(19) United States
(12) Patent Application Publication
(10) Pub. No.: US 2026/0127172 A1
(43) Pub. Date: May 7, 2026

(54) SYSTEMS AND METHODS FOR EXTRACTING PUBLIC INFORMATION BOOK (PIB) DATA FROM NEWS AND EVENT STREAMS

(71) Applicant: Wells Fargo Bank, N.A., San Francisco, CA (US)

(72) Inventors: Shobha Duggirala, San Francisco, CA (US); Ashish B. Kurani, Hillsborough, CA (US); Amruth Kumar, San Francisco, CA (US); Antonio Iniguez, San Francisco, CA (US); Nick Heim, San Francisco, CA (US); Justin Robert Wolf, San Francisco, CA (US)

(73) Assignee: Wells Fargo Bank, N.A., San Francisco, CA (US)

(21) Appl. No.: 19/434,803

(22) Filed: Dec. 29, 2025

Related U.S. Application Data
(63) Continuation of application No. 18/734,488, filed on Jun. 5, 2024.
(60) Provisional application No. 63/471,453, filed on Jun. 6, 2023.
(60) Provisional application No. 63/544,865, filed on Oct. 19, 2023.
(60) Provisional application No. 63/549,411, filed on Feb. 2, 2024.

(51) Int. Cl. G06F 16/2453; G06F 16/248

(52) U.S. Cl. CPC G06F 16/24542; G06F 16/248

(57) ABSTRACT

At least one aspect of this disclosure is directed to method of scraping, by a first computing system, one or more first data sources of the first computing system, and one or more second data sources of one or more external computing systems, to compile a first dataset, standardizing, by the first computing system, the first dataset to generate a standardized dataset, applying, by the first computing system, a first artificial intelligence (AI) algorithm to assign labels to data entries of the standardized dataset, compiling, by the first computing system, the standardized dataset having the labels assigned to the respective data entries in a database, receiving, by an AI interface of the first computing system, a query from a computing device, and generating, by the first computing system, a response to the query for delivering via the AI interface to the computing device.

### CROSS-REFERENCE TO RELATED PATENT APPLICATIONS

This Application is a continuation of U.S. application Ser. No. 18/734,448, filed Jun. 5, 2024, which claims the benefit of and priority to U.S. Provisional Application Ser. No. 63/471,453, filed Jun. 6, 2023, U.S. Provisional Application Ser. No. 63/544,865, filed Oct. 19, 2023, and U.S. Provisional Application Ser. No. 63/549,411, filed Feb. 2, 2024, the contents of each of which are incorporated herein by reference in their entirety.

### TECHNICAL FIELD

The present disclosure relates to systems and methods for an intelligent banking service. More specifically, the present disclosure relates to systems and methods of providing curated datasets according to data from disparate data sources using an intelligent banking service which leverages artificial intelligence (AI) modeling and cross-platform data to provide real-time or nearly real-time information in response to inquiries.

### BACKGROUND

Various settings require access to information to make informed decisions. In various banking contexts, such as preparing for an investment banking meeting, a user must perform data gathering, presentation creation with the gathered data, and coordinate schedules with the pertinent personnel for the presentation. These tasks consume valuable time and resources, often leading to inefficiencies. Additionally, such tasks often involve pulling duplicative or redundant data across multiple platforms, accessing each of such platforms independently, and compiling the data to generate the deliverable. This leads to increased bandwidth occupancy as well as increased processing power requirements.

### SUMMARY

Systems, methods, and computer-readable media for providing curated datasets may include a first computing system which scrapes one or more first data sources of the first computing system, and one or more second data sources of one or more external computing systems, to compile a first dataset. The first computing system may standardize the first dataset to generate a standardized dataset. The first computing system may apply a first artificial intelligence (AI) algorithm to assign labels to data entries of the standardized dataset. The first computing system may compile the standardized dataset having the labels assigned to the respective data entries in a database. The first computing system may receive, via an AI interface, a query from a computing device. The first computing system may generate a response to the query for delivering via the AI interface to the computing device.

In some embodiments, the query includes an inquiry for information relating to an enterprise, and the response includes values for a plurality of fields relating to the enterprise. In some embodiments, the one or more first data sources include a customer relationship management (CRM) platform and a document database. In some embodiments, generating the response includes the first computing system generating a plurality of tokens representing the query, encoding each token into a corresponding encoded token, applying the encoded tokens to an AI model to determine a context associated with the query, requesting one or more data entries from the database and/or from the one or more first data sources or the one or more second data sources according to the determined context; applying data corresponding to the one or more data entries and the encoded tokens to the AI model, and generating the response based on an output from the AI model.

In some embodiments, the first computing system may scrub the response to the query based on a user of the first computing device. In some embodiments, the first computing system generates the response to the query using at least a portion of the data from the database populated with the standardized dataset. In some embodiments, the first computing system trains the first AI algorithm, using a training dataset including a plurality of standardized data entries and corresponding labels associated with respective data entries. The first computing system may deploy the first AI algorithm responsive to the first AI algorithm satisfying a training criteria. In some embodiments, the first computing system generates the response to the query by applying data corresponding to the query to a second AI algorithm, the second AI algorithm configured to generate a response to the query using data from the database.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

Before turning to the Figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

FIG. 1 is a schematic diagram of a computing system for providing an intelligent banking service, according to an exemplary embodiment.

FIG. 2 is a diagram of a data flow for the computing system of FIG. 1, according to an exemplary embodiment.

FIG. 3 is a diagram of an output generation circuit of the computing system of FIG. 1, according to an exemplary embodiment.

FIG. 4 is a diagram of a staged processing flow for providing custom curated information in one or more formats (e.g., as a report), according to an exemplary embodiment.

FIG. 5A-FIG. 5B are example user interfaces showing a query to and response from the computing system of FIG. 1, according to an exemplary embodiment.

FIG. 6A-FIG. 6F are example user interfaces showing a dialogue with the computing system of FIG. 1, according to an exemplary embodiment.

FIG. 7 is a flowchart showing an example method of providing an intelligent banking service, according to an exemplary embodiment.

FIG. 8-FIG. 18 are example user interfaces showing a presentation of PIB book data and presentations with the computing system of FIG. 1, according to an exemplary embodiment.

### DETAILED DESCRIPTION

In various embodiments, this disclosure relates to providing custom, curated information or datasets according to data from disparate data sources. As technology and computing becomes more prevalent across sectors and industries, data is increasingly ubiquitous. In various industries, such as in the financial or investment banking industry, the use of data for providing projections, M&A recommendations, and the like is increasingly prevalent. However, such data may be in various formats, maintained in various data sources, and updated at various intervals. As such, it can be challenging to implement and deploy a solution which provides curated information across the various platforms and sources of the data.

According to the systems and methods of the present solution, a computing system may provide an artificial intelligence front-end or interface (referred to as an intelligent banking service) which provides custom curated information or datasets using data from across multiple disparate data sources (including internal/external data sources). In various embodiments, the computing system may perform staged processing using various iterations/types of modeling, to produce or otherwise provide the curated datasets. Such implementations may increase the accuracy of deliverables, deliver results in real-time or near real-time, and provide results from across the data sources in a simplified interface which can easily be adapted for various deliverables.

Aspects of the present solution are directed to an interactive knowledge platform for investment bankers that quickly empowers them with everything they need to know about their clients, with up-to-date information from news and other current event sources. This platform can thus create and summarize external data sources (e.g., news) and client research materials automatically by leveraging a combination of generative AI, externally available data sources, and data-visualization tools, to achieve a technical improvement to generate human-consumable data that reflect current business, market, and social conditions beyond the capability of manual processes. For example, a system according to this disclosure can continuously re-shape content provided to the system through a virtual assistant driven by generative AI.

Various examples according to this disclosure are as follows. A system executes a method to write a PIB. PIB stands for “Public Information Book” and is a PDF that combines a number of files to help provide an overview of a company. PIBs can be made for both public and private companies. A PIB for a public company contains multiple sections. The PIB for a public company contains company information/earnings transcripts. The PIB for a public company contains equity research reports. The PIB for a public company contains company filings & presentations. The PIB for a public company optionally contains recent news. The PIB for a public company contains industry reports if available.

PIBs start with a cover page that has a format that serves as a quick way for the reader of the PIB to see all its contents and quickly get to each section. For example, each item on a table of contents is linked to the page the document starts at. The company information section provides an in-depth overview of the given company. For public companies, the section usually includes earnings transcripts for the past three quarters. Earnings transcripts can be downloaded from Bamsec or Factset. For private companies, the section usually contains Factset Tearsheet, or Pitchbook profiles of the company, along with the company's product overview snippets from their website.

The tearsheet is a high-level overview of a given company pulled from FactSet. The tearsheet is typically a 10-12-page PDF containing information on the company's financials, governance, management, ownership, M&A history, and many more figures. Below are the steps to compile a tearsheet. The system downloads the company snapshot. The system then downloads the board & management page. The system then downloads the shareholder overview. The system then downloads the M&A overview. The system then downloads the shark repellent summary.

The Equity Research (ER) section contains at least two reputable equity research reports after earnings release of each quarter, depending on the number of quarters in the transcripts section above for public companies. For example, if the top transcript section included three past quarters, then the ER section needs to contain at least six ER reports in total, and extra initiation reports if released in the past six months. However, it is not always required to cover the past three quarters. For example, a report can only discuss the most recent quarter. The number of quarters covered in the ER section is consistent with the transcript section. The Equity Research section is a compilation of Equity Research reports and Initiation of Coverage reports (IOC). To compile these, the system performs the following steps. The system logs in to FactSet. The system then receives typed input for the desired company in the search bar. The system then filters for research. The system then receives typed input for “Initiation Coverage.” When looking for an IOC, it is important to make sure that it is the sole company being covered in the IOC and not lumped in with other companies. It is also important to make sure that the report is coming from a credible source. The system then repeats the same steps above, but for the most recent quarter equity research reports.

The Company Filings Section contains information regarding a company's reported financials, earnings, including reports and calls, and presentations. For example, investor presentations are obtained from a company's Investor Overview section of their website. They usually release earnings presentations for each quarter, and they will have Investor. Presentations occasionally and Analyst Presentations for any events they hosted. All of those presentations will be available to download in PDF on their website. The number of quarters to cover will also need to be consistent with the transcript section and the ER section above, in an example embodiment.

An example for making a PIB for a Private Company is discussed as follows. Often Investment Bankers will also cover private companies. Less public data is typically available for making a PIB for a private company. Public articles, however, can provide an understanding of how well a private company is doing. Like a public company, a PIB for a private company can have a section that details a private company. The system can compile a PIB for a private company by downloading a Pitchbook Profile, finding an article or company website overview about the company, finding articles on recent M&A activity, and finding an overview on customers/partnerships of the private company.

An example for generating investor & funding information is discussed as follows. This section compiles information regarding the ownership/funding background of a private company. The system finds 3-4 articles describing any new funding rounds, acquisitions where the private company was the acquired company, or any other ownership/investor news. An example for generating recent developments is discussed as follows. This section provides information on any new partnerships formed, product releases, regulatory changes that effect the company, or the use of new technology. The system finds 3-4 articles that allows the reader to get an idea on recent business & product activity. Sometimes the PIB is requested with requirements on the recent developments, and the system will tailor our articles accordingly. For example, requirements could be to only include their recent efforts in AI, or recent acquisition actions. An example for generating industry reports is discussed as follows. If available, Magic Quadrants or Market Analysis reports from Gartner or IDC are added at the end, especially for Software companies. An example for compiling the PIB is discussed as follows. Once all the PDFs have been downloaded, the last step is to all the PDFs. Put the files in the order outlined above with a table of contents page on the front and download the final copy.

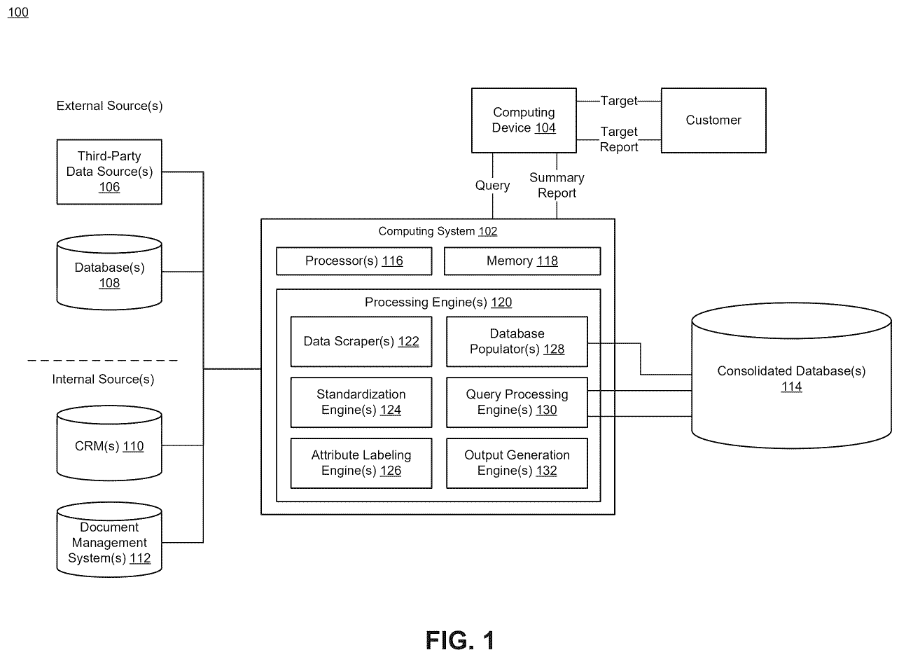

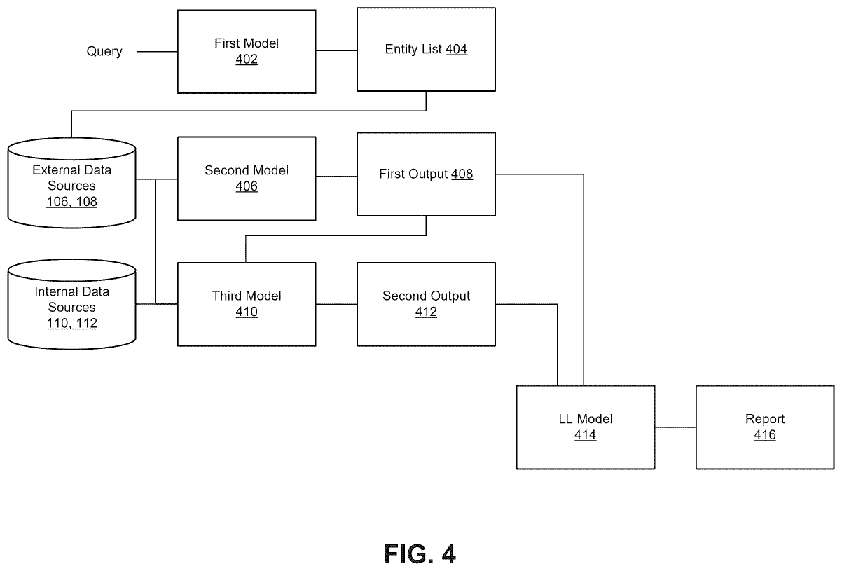

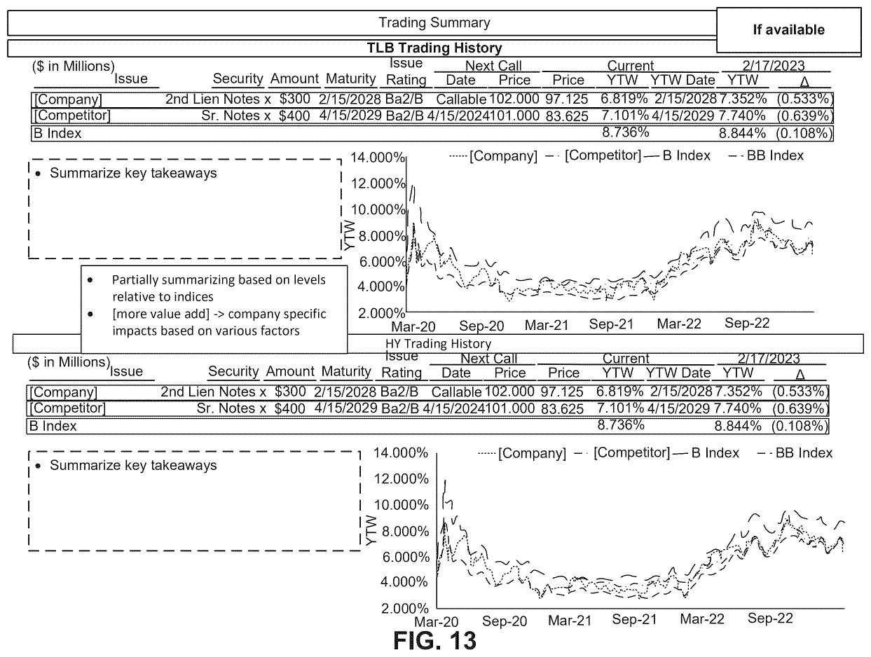

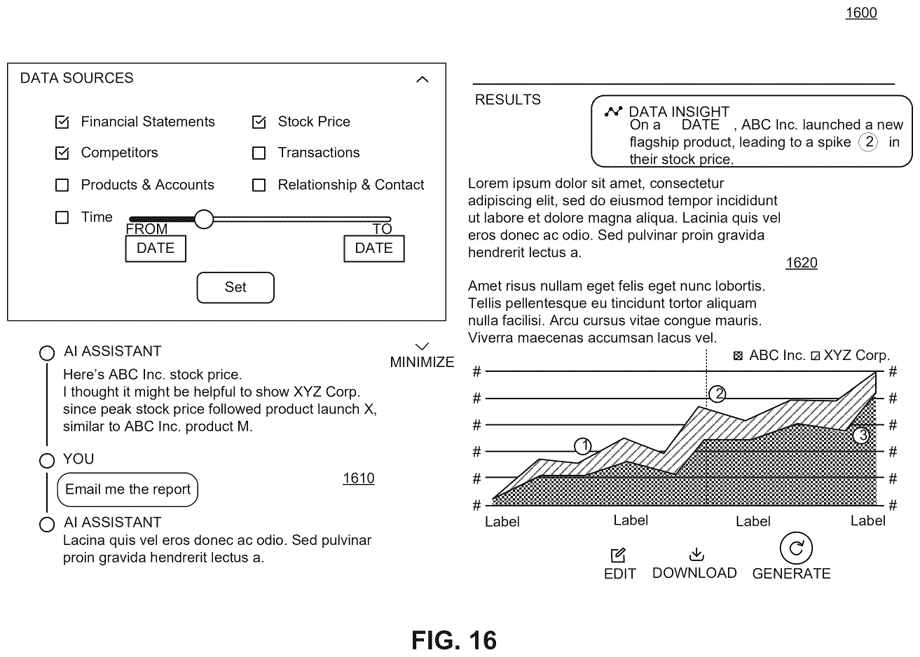

Embodiments as discussed herein provide an interactive knowledge platform for interested parties, such as investment bankers, that quickly empower them with everything these parties need or may need to know about their clients. One example platform is discussed as follows. This computing system platform (e.g., according to the example system of FIG. 1) has the ability to create and summarize client research materials automatically by leveraging a combination of generative AI, externally available data sources, and data-visualization tools (e.g., according to one or more of the examples of FIG. 4, FIG. 13, or FIG. 16, but not limited thereto). In addition, this computing system platform allows investment bankers to continuously re-shape content provided to them through a virtual assistant that is driven by generative AI (e.g., according to the example user interface of FIG. 16). The platform includes one or more features as discussed herein.

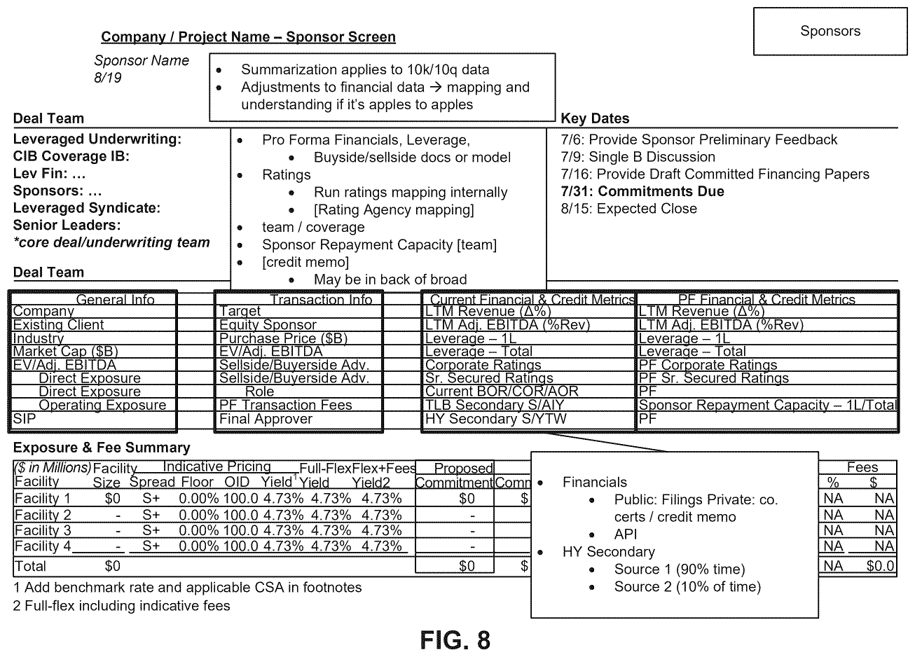

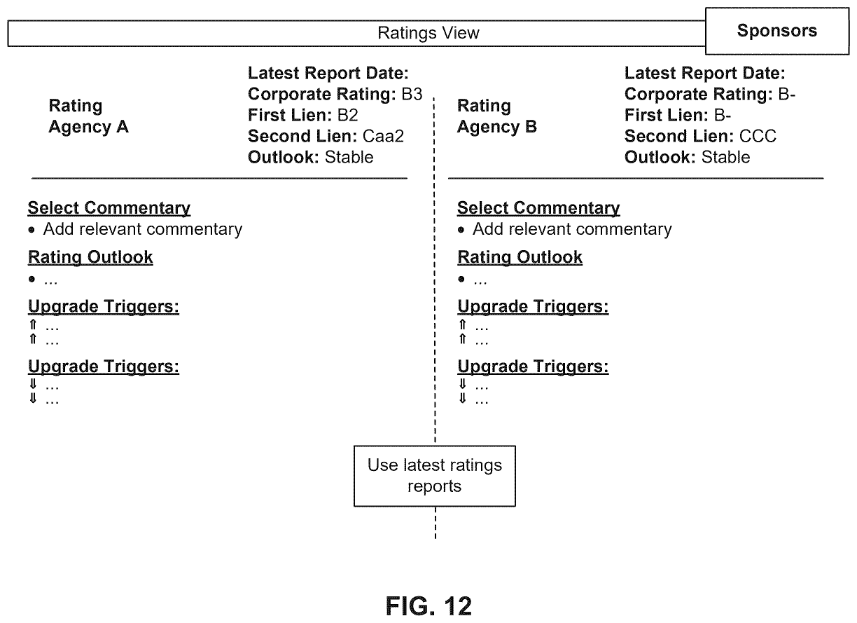

For example, the platform includes a document creation automation feature (e.g., according to any of FIG. 8-FIG. 17). With this feature, investment bankers submit one or more prompts via a computing device (e.g., according to FIG. 1), and a computing system (e.g., according to FIG. 1) executes the document creation automation feature to automatically collate readily available external content into a standard format document that the team may require for underwriting clients. For example, prompts could include any one or more of the following (but are not limited thereto): category and sub-categories desired selection, data sources that should and should not be included, a time horizon for the data, and a request to obtain relevant news stories, sources, and desired time horizon for the content, from one or more internal or external data sources.

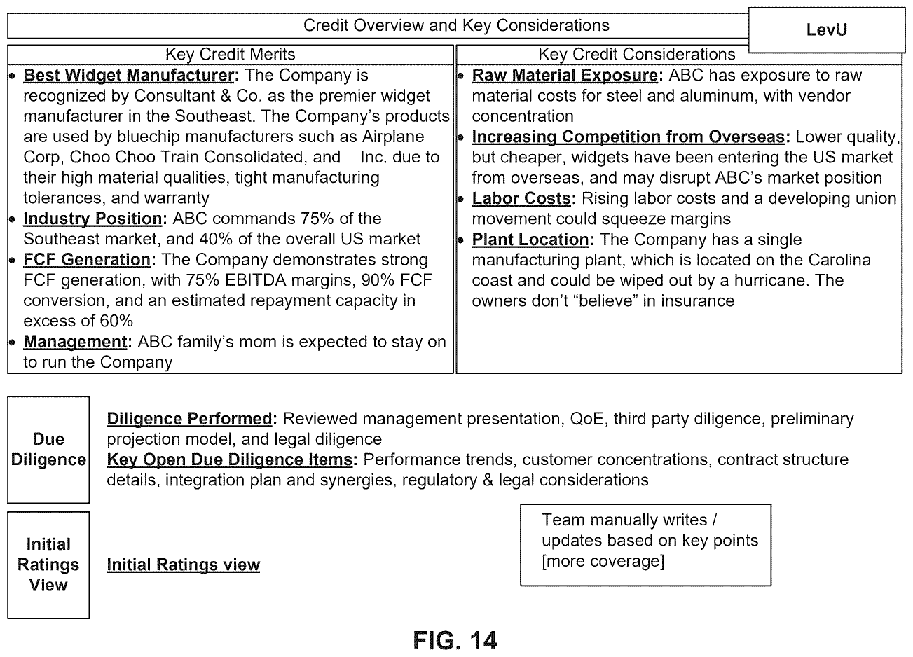

The platform may also include a document summarization feature (e.g., according to FIG. 13-FIG. 14, but not limited thereto). This feature has the ability to create summaries of external and readily available documents automatically with just a handful of prompts by leveraging large language models. For example, Investment Banker A can upload a combination of a document URL and a word file to computing system 102 and receive a response at computing device 104. The response can be presented as, for example, one or more of the user interfaces of FIG. 8-FIG. 17. The response can include summarized information responsive to the query, summarized based on desired word count, topic, sections to include/exclude, or even tonality. The document summarization feature eliminates or may eliminate the need for Investment Banker I to write one or many customized summaries related to a specific deal type that they intend to pursue, in connection with creation of a PIB. These summaries can be relatively long, such as greater than five pages and particularly twelve pages or longer, but also shorter than that, such as less than one-thousand words (e.g., 500 words) depending on the audience and type of deal.

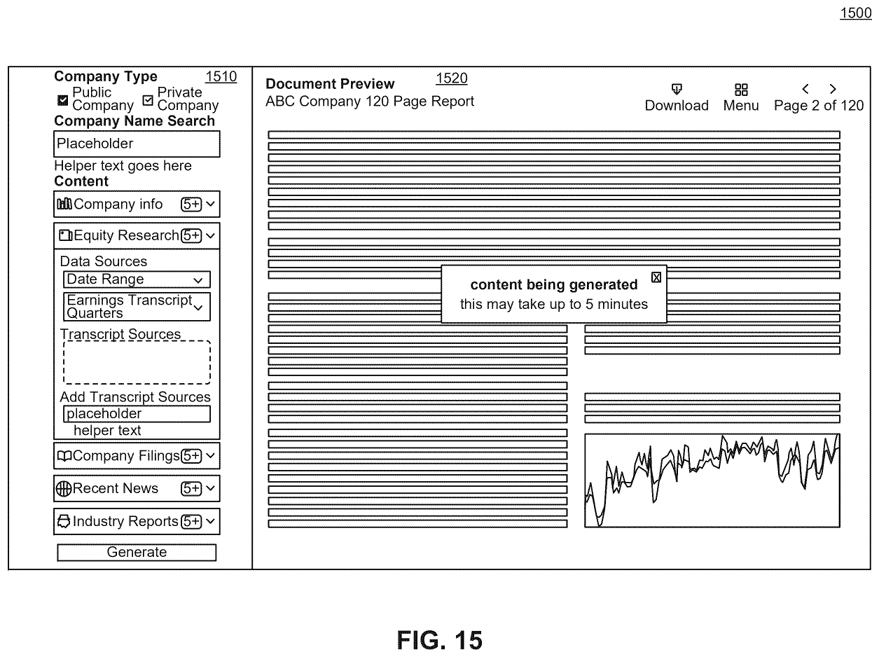

The computing system platform (e.g., according to FIG. 1) may also includes a document question and answer (Q&A) interactions feature (e.g., according to FIG. 15). With this feature, interested parties, such as investment bankers, can continuously ask questions to the created PIBs and summaries as if there was a human assistant on the other side. For example, when a user receives their generative AI summary or PIB, they might prompt the tool with a series of asks including, one or more of the following: “delete section “X” and add more context to section Y about whether earnings for the past X years are trending up or down,” “For section Y, create a 100-word summary for me,” or “change the tonality of the entire document to be more professional or witty depending on the audience.” The document Q&A interactions feature can eliminate the need for investment bankers to manually review manually-created documents to generate insights within a rapid and ever-changing economy.

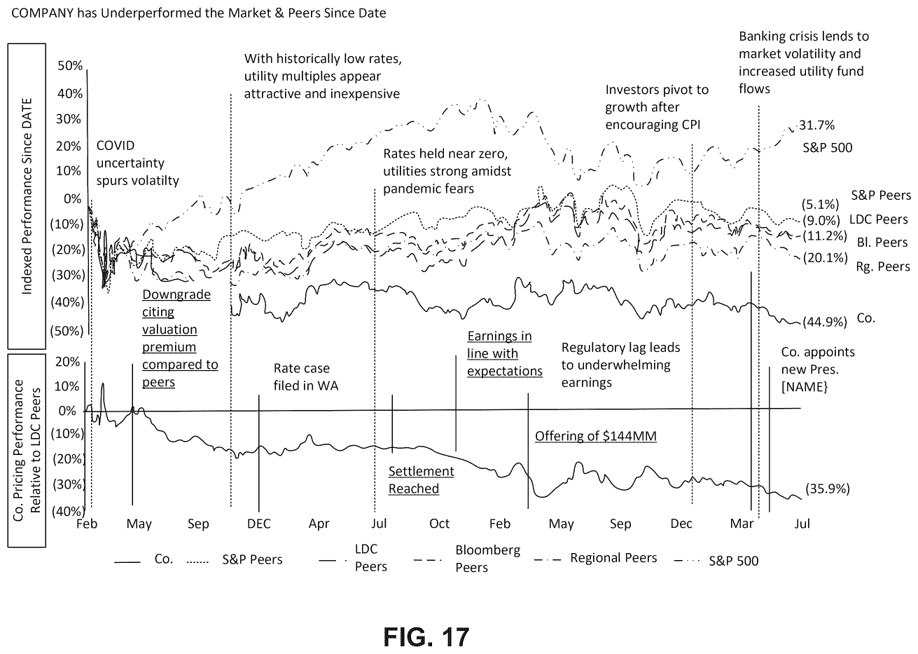

The computing system platform may also include a data visualization feature (e.g., according to FIG. 17). With this feature, interested parties, such as investment bankers, can automatically generate charts that compare their clients or targets against peer groups and highlight relevant news stories as annotations (to explain various peaks and valleys in the data). Annotations can be sourced through socials channels, press releases, and news articles through one or more API calls utilized by the computing system. Additionally, annotations can even be summarized in paragraph form and exported (e.g., via the generative AI feature). Some sub-features for data visualization may also include specifying variables such as data source, peer groups of interest, market cap range for peer groups, and time series; the ability to save, recall, or download the chart; and/or the ability to specify percentage change ranges where annotations should be included. The data visualization feature can eliminate the need for an investment banking team to manually create certain documents, such as equities trading charts, from a handful of data sources which are intended to compare a subject company against one or many peers (to derive benchmark performance (e.g. Company X is performing better than their peers by X % over Z period of time). Conventionally, the team constantly updates these charts and in doing so they must log into various data sources, download the data to excel, run formulas, and export to a presentation creation tool. These manual processes may not provide insight at sufficient speed to react to market conditions.

A system as discussed herein can obtain annotations via communication interfaces coupled with social media channels, news aggregators providing press releases and news articles, or any combination thereof, but is not limited thereto. Additionally, the system can summarize annotations in paragraph form, and exported. Some sub-features for data visualization could include: Specify variables such as data source, peer groups of interest, market cap range for peer groups, and time series. The ability to save, recall, or download the chart. The ability to specify percentage change ranges where annotations should be included. For example, a computing system can receive input from a computing device to enter a parent company name into a field. The field can auto-populate a list of available options that can be selected via user input.

For example, the computing device can, based optionally on one or more instructions or data from the computing system, provide output to name the file and also add a managing director first and last name. For example, the computing system can populate one or more performance-related metrics in the documents list view on the home page for any previously created PIB. For example, performance-related metrics can correspond to financial metrics over time or at a given time. For example, the computing device can, in response to selection of a given data source t of choice (while in the PIB creation process), provide an option of receiving a user selection of whether to include research from data source corresponding to independent equity research providers.

For example, the computing device can, when creating a PIB for a private company, provide an option of selecting comparable “public” companies. For example, the computing system can instruct the computing device to provide a prompt for selecting an industry, followed by a subsequent prompt to select specific companies. For example, the computing device can, when creating a PIB, auto-populate one or more transcript sources, based on data source selected to create the PIB (e.g., auto-population can be conducted only if the given source is available). For example, the computing device can, in connection with creating a PIB, present a table of contents that appears on the screen of the computing device with check boxes next to each section and sub-section, that can be selected by a user input to hide aspects of the created PIB document for a specific audience. For example, the computing system can receive the selections and only render or export portions of the PIB associated with checked boxes. For example, the computing device can, in connection with creating a PIB, present a table of contents that appears on the screen of the computing device to include a hyperlink to one or more pieces of content (e.g., news articles). For example, the computing device can, in the process of creating a Private Company PIB, receive input to select comparable Public Company data. For example, the computing device can present a user interface to receive input from the user to select an industry, a sub-industry, or one or one companies from a list.

The systems, methods, and computer-readable media discussed above and herein provide technical improvements to reduce time for users, such as investment bankers, to create specific research materials. Reduction in time can also result in further advantages including increased conversion and revenue generated. The average times to complete each task have been notated below. This technical solution can thus decrease use of resources and increase time-to-market beyond the capability of manual processes. For example, the systems, methods, and computer-readable media described herein can reduce time devoted to PIB creation that would otherwise require an average time to complete of, for example, two-thousand hours (e.g., 200 associates×5 PIBs per month×2 hours per PIB equals 2,000 hours). The systems, methods, and computer-readable media can further reduce time required for equities trading data visualizations with annotations that would otherwise require an average time to complete between experienced and inexperienced bankers of more than two hours, where each separate charts would also need annotations and take a similar amount of time.

The systems, methods, and computer-readable media described herein also provide the technical solution of integrating generative AI in non-routine or conventional manner to generate improved graphical user interfaces and selective summarize and/or combine previous disparate data sources. Combination of these disparate data sources (e.g., news article and analyst remarks) is a process that would otherwise require conversion of the data sources into a uniform data type. Here, the generative AI may summarily combine the system may present such information in an intuitive and easy-to-understand manner. This result is advantageous as appealing to users as well as reducing network traffic otherwise required to access these data sources and processing power to combine or attempt to combine these data sources. These and other features and benefits are described more fully herein below. As discussed herein, news articles can include, but are not limited to recent news released within a given time from the present. For example, the computing system can receive as input one or documents or presentations for one o more industry reports relevant to a company. The computing system can process a high volume of industry reports (e.g., thousands) to determine relevance of each industry report or portion of industry report at a speed and accuracy beyond the capability of manual processes.

Referring now to FIG. 1, depicted is a block diagram of a system 100 for providing curated datasets across disparate data sources, according to an exemplary embodiment. The system 100 may include a computing system 102 (which may include or provide an intelligent banking service) communicably coupled to a computing device 104 and various data sources. The data sources may include, for example, external data sources (e.g., third party data sources 106, databases 108, etc.) and internal data sources (e.g., customer relationship management (CRM) platforms 110, document management system(s) 112, etc.). As described in greater detail below, the computing system 102 may be configured to populate at least one consolidated database (or databases) 114 using standardized, labeled (or tagged) data from the data sources. The computing system 102 may be configured to receive a query from the computing device 104, pull data from the consolidated database(s) 114, and generate a response to the query.

The system 100 may include at least one computing device 104. The computing device 104 may be or include any type or form of a computing device, such as a personal computer, laptop, mobile device, smartphone, tablet, or any other device. In some embodiments, the computing device 104 may be operated by a user associated with a provider/entity of the computing system 102 (e.g., such that the user has access to the internal sources). For example, the user may be an investment banker or some other user associated with the entity. In some embodiments, the computing device 104 may be operated by a third-party user (e.g., an end-user, an investor, etc.). As described in greater detail below, the user may generate a query (e.g., via a client application associated with the computing system 102). In various embodiments, the computing system 102 may be configured to apply various policies/access rights to the user (e.g., based on the particular user, the type of user, etc.), for generating the response to the query.

The computing system 102 may configured to access various external sources. The external sources may include third-party data sources 106 and databases 108 (generally referred to as sources or external sources 106, 108). In various embodiments, the external sources may provide financial industry information used for data collection, research, analysis, market insights, and/or analytics purposes. The third-party data sources 106 and databases 108 may include one or more of, for example and non-exhaustively, FactSet, Refinitiv, CapIQ, S&P, Moody's, Bloomberg, Markit, Syndtrak, Dunn & Bradstreet, Edgar, etc. The computing system 102 may be configured to access various internal sources. The internal sources may include, for example, CRM(s) 110, document management systems 112, internal databases, etc. In various embodiments, the internal sources may be configured to maintain and provide various internally generated and maintained financial industry information, such as customer or deal-specific information (e.g., maintained in the CRM(s) 110), internal deal books, bookbuild platform, or the like.

The computing system 102 may ingest data corresponding to various industries and sub-industries (e.g., banking, consumer and retail, diversified financials, energy and power, healthcare, industrials, real estate, gaming, lodging and leisure, technology, media, and telecommunications, to name a few non-limiting possibilities). The computing system 102 may ingest external data elements (e.g., from the external sources 106, 108) including public financials, public filings, client capitalization, enterprise value, equity value, projections, trading levels, assets, indices, press releases, transcripts, company and debt ratings, interest rates, secondary trading levels, deal document data rooms for banks/investors, fundamental data (20 years history), security prices (daily), ownership fragmentation, shareholder voting pattern (voting topics and takeover correlations), analyst recommendations, management turnover, governance ratings, ESG scores, and journey and targets of previous acquisitions, to name a few possibilities. The computing system 102 may ingest internal data elements (e.g., from internal sources 112) including company contact information, industry or sector information, compliance decisions and fees, deal or coverage teams from the institution, deal documents (e.g., lender presentations, term sheets, credit agreements, merger agreements, fee letters, commitment letters), investors in deal (e.g., at closing), historical deals (e.g., pricing, size, covenants, maturity date), to name a few possibilities.

The computing system 102 may be owned by, associated with, or otherwise operated by a provider institution (e.g., a bank, a credit union, or other financial institution). The provider institution may be associated with the computing device 104. For example, the computing system 102 may be a computing system of the provider institution, and the computing device 104 may be operated by or associated with an employee, banker, or other user associated with provider institution.

The computing system 102 may include a processing circuit including one or more processors 116 and one or more memory devices 118. The processor(s) 116 may be implemented or performed with a single-or multi-chip processor, a digital signal processor (DSP), an application specific integrated circuit (ASIC), one or more field programmable gate array (FPGAs), or other suitable electronic processing components. A processor may be a microprocessor, or, any other suitable processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the circuits of the processor 116 may include or otherwise share the same processor which, in some example embodiments, may execute instructions stored, or otherwise accessed, via different areas of memory). Alternatively or additionally, the one or more processors 116 may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The processing circuit may include at least one memory 118. The memory 118 (e.g., memory, memory unit, storage device, etc.) may include one or more devices (e.g., RAM, ROM, Flash memory, hard disk storage, etc.) for storing data and/or computer code for completing or facilitating the processes, layers, and modules described in the present application. The memory 118 may be or include tangible, non-transient volatile memory or non-volatile memory. The memory 118 may also include database components, object code components, script components, or any other type of information structure for supporting the activities and information structures described in the present application. According to an exemplary embodiment, the memory 118 may be communicably connected to the processor(s) 116 via the processing circuit and includes computer code for executing (e.g., by the processing circuit and/or the processor(s) 116) one or more processes described herein.

The computing system 102 may include one or more processing circuits 120. The circuits described herein (also referred to herein as a processing circuit, sub-processing circuit, and/or custom information curation and generation processing system or circuit) may be or include any device, component, element, or hardware designed or configured to perform various functions of the computing system 102. The processing circuit(s) 120 may include one or more data scraper(s) 122, standardization circuit(s) 124, attribute labeling circuit(s) 126, database populator(s) 128, a query processing circuit 130, and an output generation circuit 132. In various embodiments, one or more of the processing circuits 120 may be combined with one or more other processing circuits 120. Additionally or alternatively, one or more processing circuits 120 may be divided or sub-divided into multiple processing circuits 120. The processing circuit(s) 120 may include, for example, one or more processors of a processing circuit (such as the processor(s) 116) configured by corresponding executable instructions to perform various functions associated therewith.

The computing system 102 may include one or more data scraper(s) 122. The data scraper(s) 122 may be or include any device, component, element, or hardware designed or configured to ingest, receive, retrieve, access, or otherwise scrape data from the internal and external data sources. In some embodiments, the data scraper(s) 122 may be configured to automate the extraction of data from various websites or databases (such as the sources 106-112). In some embodiments, the data scraper(s) 122 may be configured to receive credentials for certain data sources/websites (e.g., where the data sources are password protected or otherwise provide limited access to particular users or user-types). In some embodiments, the data scraper(s) 122 may be configured to scrape data sources/websites based on predefined or desired information. For example, the data scraper(s) 122 may be configured to maintain an association between particular types of data/desired information and corresponding data sources for querying. The data scraper(s) 122 may be configured to transmit, communicate, send, or otherwise provide queries or requests to a target database, accessing the data within the database, and retrieving the desired information. The data scraper(s) 122 may be configured to generate SQL queries or API calls to interact with the database(s) and extract and/or ingest relevant data based on specific criteria or search parameters.

The computing system 102 may include one or more standardization circuit(s) 124. The standardization circuit(s) 124 may be or include any device, component, element, or hardware designed or configured to standardize data ingested or scraped by the data scraper(s) 122. In various embodiments, because the data scraper(s) 122 may access different data sources which may have different data formats, the standardization circuit(s) 124 may be configured to standardize the data formats/values, etc. across the ingested data. The standardization circuit(s) 124 may be configured to perform various data mapping and/or transformations to establish a standardized/unified data format across the sources. For example, the standardization circuit(s) 124 may be configured to identify common data elements across the data source(s), create a standard schema, and map data from the various data sources according to the standard schema. As another example, the standardization circuit(s) 124 may be configured with and/or access various data integration or middleware tools for mapping, transformation, and synchronization. In various embodiments, the standardization circuit(s) 124 may be configured to apply the data mapping/transformations/etc. to data ingested by the data scraper(s) 122, to generate a standardized dataset.

The computing system 102 may include one or more attribute labeling circuit(s) 126. The attribute labeling circuit(s) 126 may be or include any device, component, element, or hardware designed or configured to determine, assign, apply, or otherwise associate various labels/tags/attributes to data entries of the standardized dataset. In some embodiments, the attribute labeling circuit(s) 126 may include or access a machine learning (ML) model or framework for programmatically labeling the data entries of the standardized dataset. For example, the attribute labeling circuit(s) 126 may be configured to receive various labeling functions for generating training labels based on various heuristics, rules, etc. The attribute labeling circuit(s) 126 may be configured to label or otherwise tag the standardized dataset using the various labeling functions. As one example, the attribute labeling circuit(s) 126 may access Snorkel, or some other machine learning framework, for labeling the standardized dataset.

The computing system 102 may include one or more database populator(s) 128. The database populator(s) 128 may be or include any device, component, element, or hardware designed or configured to update, populate, organize, store, or otherwise maintain the consolidated database(s) 114. The database populator(s) 128 may be configured to store the labeled, standardized data entries of the standardized dataset in the consolidated database 114. In this regard, the consolidated database 114 may be or include a database which consolidates data from a plurality of data sources (several of which may have different data formats from other sources). As described in greater detail below, the consolidated database 114 may be or represent training sets used as training sets for a large language model (LLM) or generative artificial intelligence (AI) platform which uses such data for respond to queries to an AI interface.

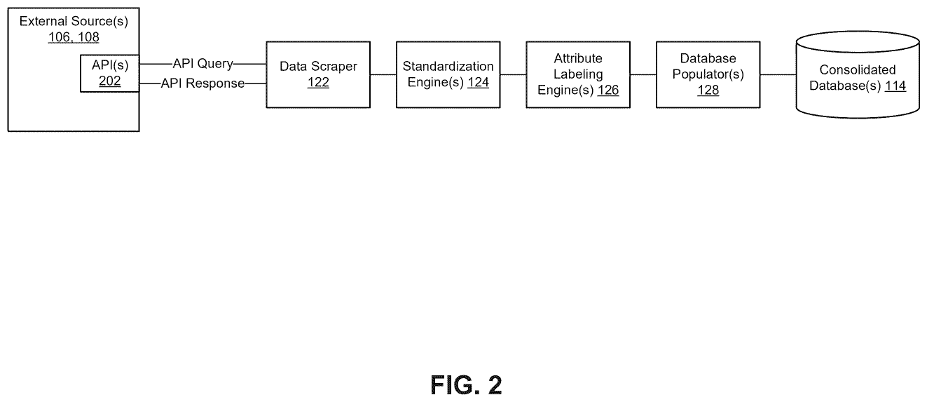

Referring briefly to FIG. 2, depicted is a data flow 202 for the computing system 102, according to an exemplary embodiment. As shown in FIG. 2, the data flow may be used for populating the consolidated database(s) 114. To begin the data flow, the data scraper(s) 122 may be configured to pull data from the external source(s) 106, 108. In some embodiments, as shown in FIG. 2, the data scraper(s) 122 may be configured to pull data from the external data source(s) 106, 108 by transmitting an API query to one or more APIs 202 of the data source(s) 106, 108, to pull a particular type/format of data. The APIs 202 may be configured to respond to the query with an API response including the requested data of the external source(s) 106, 108. While described as performing an API query and receiving a response, it is noted that the data from the external source(s) 106, 108 may be retrieved in many different ways, such as using standard query language (SQL) requests, hypertext transfer protocol (HTTP) GET requests, etc.

Once the data scraper(s) 122 receive the API response including the requested data (e.g., as a first or initial dataset), the data scraper(s) 122 may be configured to transmit, communicate, share, or otherwise provide the initial dataset with the standardization circuit(s) 124. The standardization circuit(s) 124 may be configured to apply various data mapping and transformation algorithms to the initial dataset to generate a standardized dataset. The standardization circuit(s) 124 may be configured to provide the standardized dataset to the attribute labeling circuit(s) 126. The attribute labeling circuit(s) 126 may be configured to apply various machine learning algorithms to the standardized dataset to assign various label(s) to the dataset. The database populator(s) 128 may be configured to receive the standardized, labeled dataset from the attribute labeling circuit(s) 126, and populate the consolidated database(s) 114 with the standardized, labeled dataset.

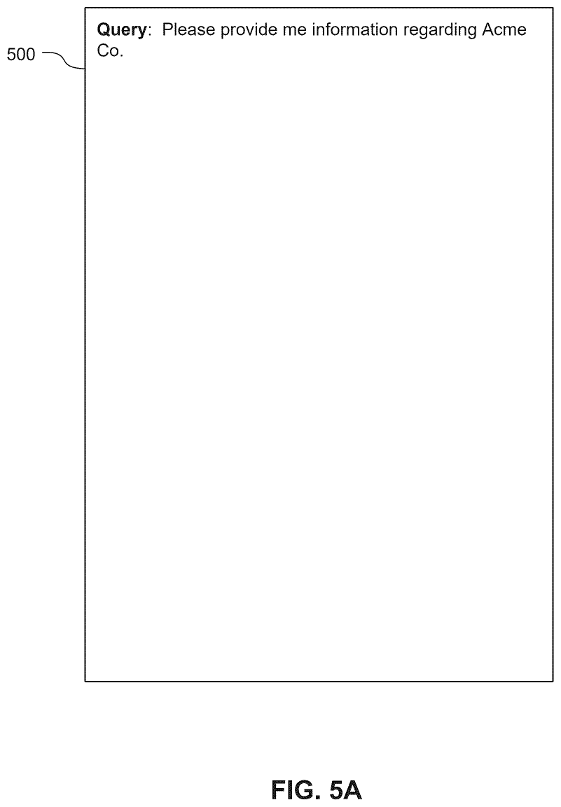

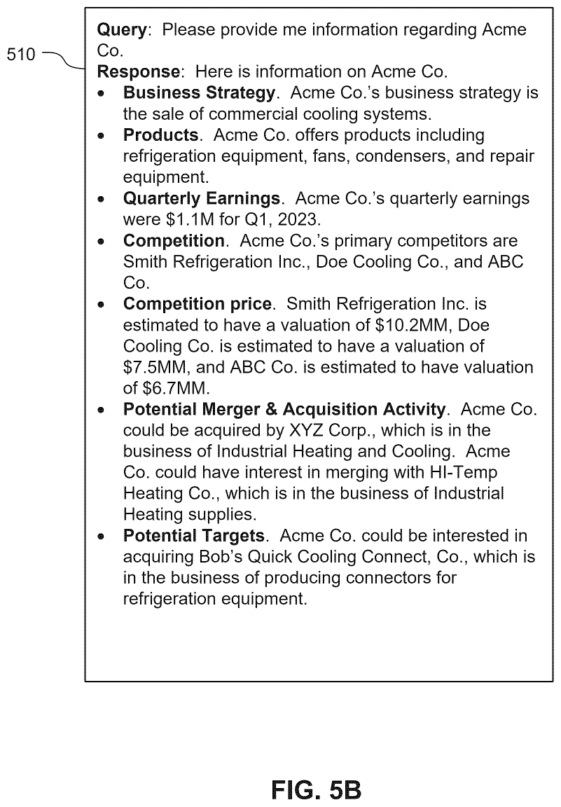

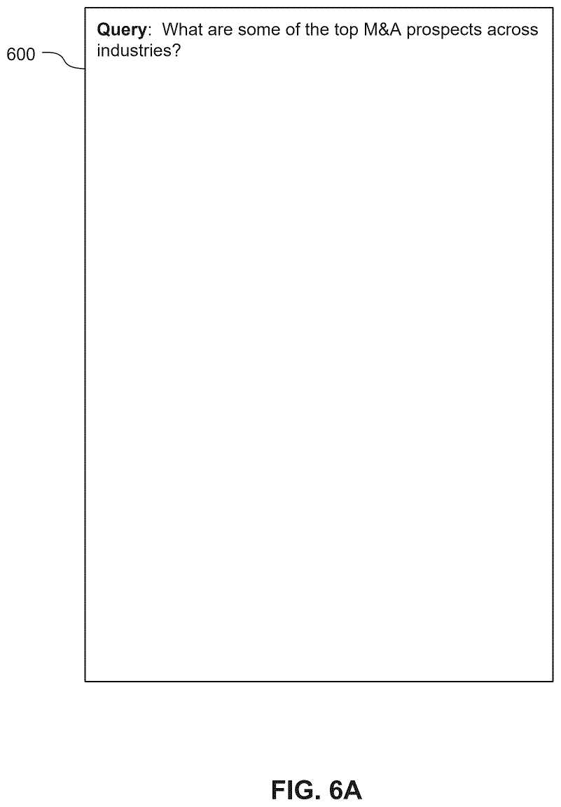

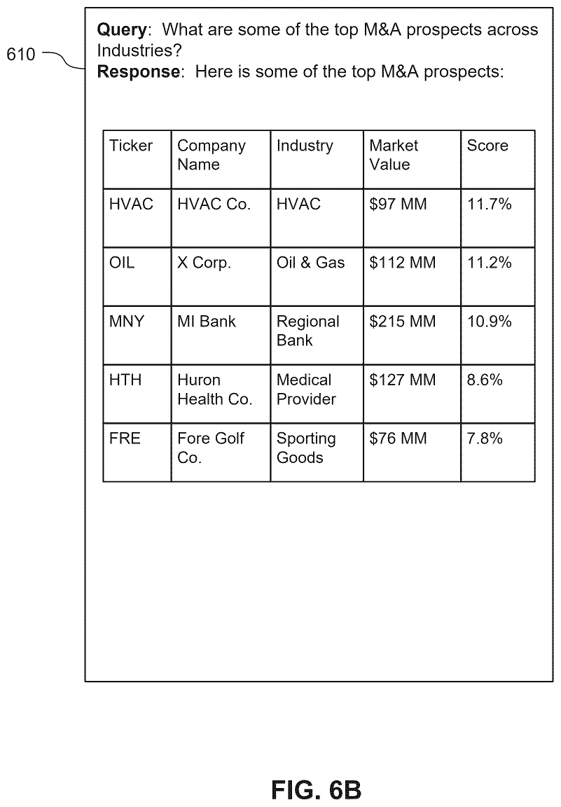

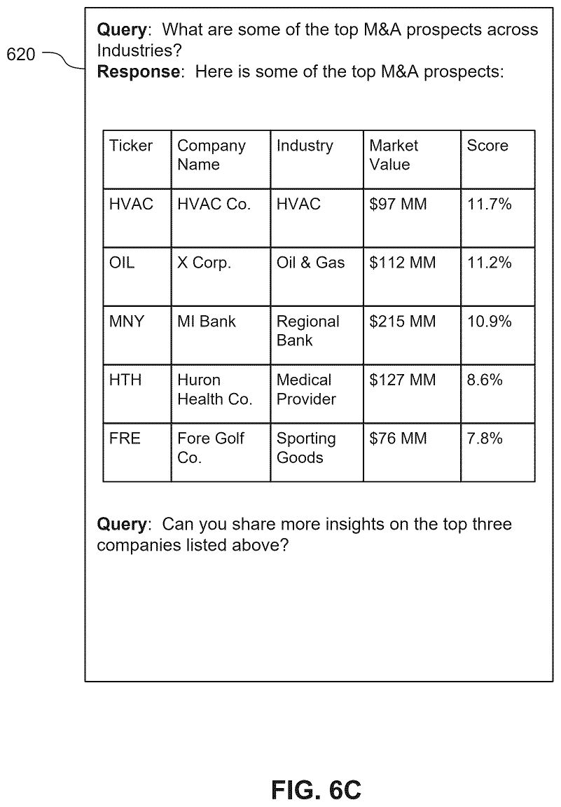

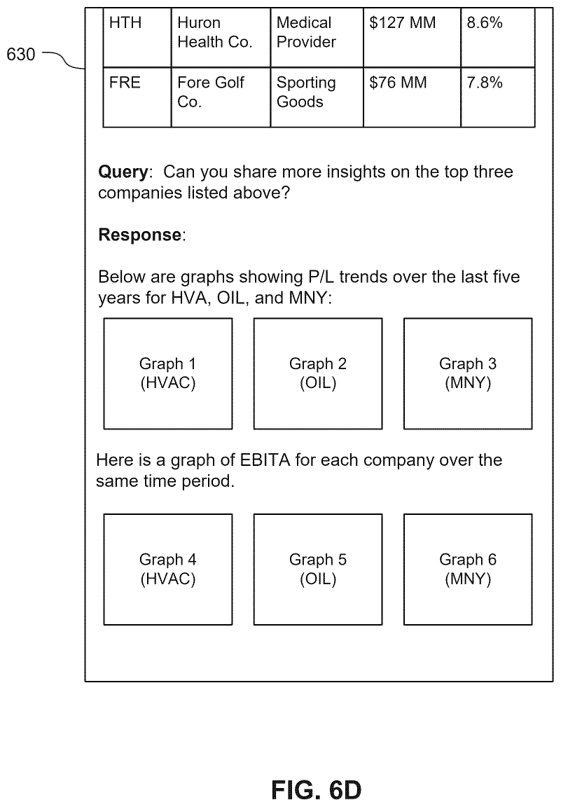

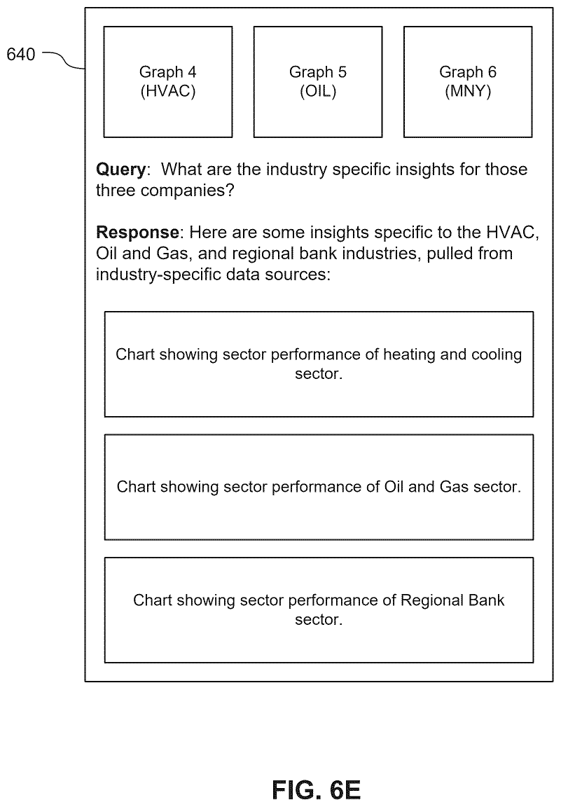

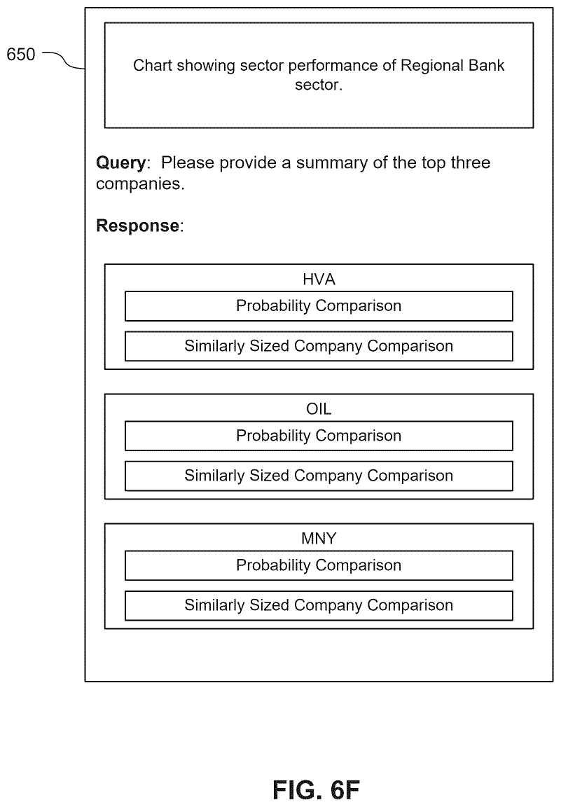

Referring back to FIG. 1, the computing system 102 may include one or more query processing circuits 130. The query processing circuit(s) 130 may be or include any device, component, element, or hardware designed or configured to analyze, parse, inspect, or otherwise process an input/prompt/query received from the computing device 104. In some embodiments, the query processing circuit(s) 130 may be configured to receive a text input (e.g., query) from the computing device 104. The text input may be or include queries similar to those described below with reference to FIG. 5A-FIG. 6F. The query processing circuit(s) 130 may be configured to tokenize the text input into tokens (e.g., phrases or passages, individual words, sub-words, punctuation, etc.). The query processing circuit(s) 130 may be configured to transform, convert, or otherwise encode each token generated for the text input into an encoded token. The encoded token may be encoded into a format (such as vector format, word embeddings, etc.) which is compatible with the output generation circuit 132, as described in greater detail below.

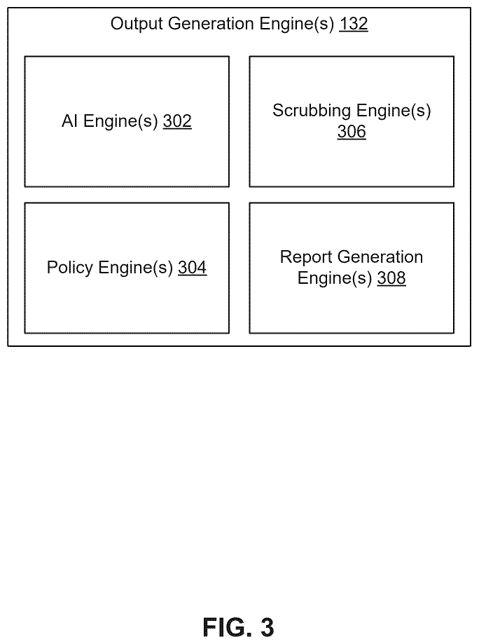

Referring now to FIG. 1 and FIG. 3, depicted in FIG. 3 is a block diagram of the output generation circuit(s) 132 in greater detail, according to an exemplary embodiment. As shown in FIG. 3, the output generation circuit(s) 132 may include one or more artificial intelligence (AI) circuits 302, one or more policy circuits 304, one or more scrubbing circuits 306, and one or more report generation circuits 308. The circuits 302-308 may be any device, component, element, or hardware designed or configured to perform various functions associated therewith. In some embodiments, the circuits 302-308 may include, for example, one or more processors of a processing circuit (such as the processor(s) 116) configured by corresponding executable instructions to perform various functions associated therewith. Each of these circuits 302-308 are described in greater detail below.

The artificial intelligence circuit(s) 302 may be or include any device, component, element, or hardware designed or configured to employ, execute, or otherwise provide various AI-related functions. For example, the artificial intelligence circuit(s) 302 may be or include a neural network (such as a generative pre-trained transformer neural network) trained to generate responses to queries. In some embodiments, the neural network may be trained using data from, at least, the consolidated database(s) 114. In this the regard, the neural network(s) may be trained using the standardized, labeled data ingested or otherwise received from the external source(s) 106, 108 and internal source(s) 112. In some embodiments, the neural network(s) may be trained using the dataset stored in the consolidated database(s) 114 along with various examples of answers to queries. The neural network(s) may be trained by tokenizing the dataset, initializing the weights and biases of the neural network(s), feeding inputs (e.g., example queries) to the neural network(s) and using a loss function to quantify a discrepancy of the response to the queries generated by the neural network(s) to the answer. The neural network(s) may update the weights/biases based on the output/discrepancy, until the neural network(s) satisfy various testing/training criteria. At the deployment stage, the neural network(s) may be configured to receive the encoded tokenized query as an input (e.g., to an input layer of the neural network(s)), perform forward propagation of the encoded tokens to the neural network, extract features, perform non-linear transformations, perform contextual understanding, and generate an output.

In some embodiments, the artificial intelligence circuit(s) 302, upon determining a context of the query, may generate one or more queries for the consolidated database 114 and/or data sources 106-112 to obtain data relevant to the query. The artificial intelligence circuit(s) 302 may be configured to retrieve or otherwise request data which is relevant to the information which was requested. For example, if the query asks for financial information relating to a particular company (e.g., Acme Co.), the artificial intelligence circuit(s) 302, upon determining that the context of the query is financial information relating to Acme Co., may generate a query to database 114 and/or one or more of the data source(s) 106-112 to obtain information/data relating to Acme Co. The artificial intelligence circuit(s) 302 may be configured to supply the data as an input to the artificial intelligence circuit(s) 302 for generating various projections/outlook information relating to the query. In this regard, the artificial intelligence circuit(s) 302 may be configured to query for real-time or near real-time data as an input, to provide more accurate projections/reports/responses.

The policy circuit(s) 304 may be or include any device, component, element, or hardware designed or configured to assess, use, employ, or otherwise apply one or more policies to a query for generating a response. In some embodiments, the policy circuit(s) 304 may be configured to apply the policies based on a user which generated the query. For example, the policy circuit(s) 304 may be configured to maintain, include, or otherwise access various policies associated with the computing system 102. The policies may be maintained or defined by an enterprise associated with the computing system 102. For example, where the computing system 102 is a financial institution computing system, the policies may be defined or set by the financial institution. The policies may include one or more data access rules for particular users or groups of users, types of users, classifications of users, etc. As one example, the policies may include a data access rule which restricts access to certain types of responses (e.g., responses including data which was obtained or trained from internal source(s) 110) to only be provided to internal users. When the computing device 104 generates a query, the computing device 104 may be configured to transmit the query with a unique identifier associated with the user of the computing device 102 (e.g., obtained when logging into the computing device 104, when logging into a client application associated with the computing system 102, etc.). The policy circuit(s) 304 may be configured to perform a look-up function using the unique identifier, to determine whether any access rights are triggered for the user based on the policy. In some embodiments, the policy circuit(s) 304 may be configured to apply a tag, label, or otherwise associate the query with a particular response type (e.g., internal or external response, scrubbed or full response, etc.) based on whether any access rights are triggered.

The scrubbing circuit(s) 306 may be or include any device, component, element, or hardware designed or configured to cleanse, clean, or otherwise scrub the response generated by the AI circuit(s) 302 according to the policy (or policies) of the policy circuit as applied to the particular user. In some embodiments, the scrubbing circuit(s) 306 may be configured to scrub the response, to remove protected or secured data (such as internal data, or data from internal sources). The scrubbing circuit(s) 306 may be configured to remove, for example, data from the response which corresponds to data entries tagged as being sourced from the internal source(s). In this regard, the scrubbing circuit(s) 306 may be configured to generate modified response(s) which are tailored to the particular audience.

The report generation circuit(s) 308 may be configured to generate, determine, derive, or otherwise provide one or more responses (or reports) according to the output from the AI circuit(s) 302 (e.g., following scrubbing by the scrubbing circuit(s) 306). The report generation circuit(s) 308 may be configured to provide the report or responses in various formats, including for example text outputs, table outputs, visual or graphical outputs, and so forth. The report generation circuit(s) 308 may be configured to generate the reports or responses to the computing device 104 (e.g., which provided the query to the computing system 102). In some embodiments, the report generation circuit(s) 308 may be configured to compile responses to a plurality of queries within a common chain or thread into a single report. For example, the report generation circuit(s) 308 may be configured to compile the responses to each of the queries from FIG. 6A-FIG. 6F described below into a single report. Various examples of queries, responses, reports, and the like are described in greater detail below.

The report generation circuit(s) 308 may be configured to present one or more indications at one or more user interfaces corresponding to one or more portions of one or more responses (or reports) according to the output from the AI circuit(s) 302. For example, the report generation circuit(s) 308 can include one or more instructions to generate one or more presentations each corresponding to particular indications according to one or more portions of FIGS. 5B-6F. For example, the report generation circuit(s) 308 can include or correspond to one or more presentation circuits each configured to generate one or more corresponding objects based on the at least a portion of a query received as discussed herein. For example, the report generation circuit(s) 308 can include one or more of a plot presentation circuit, a visualization presentation circuit, a comparative presentation circuit, a presentation placement circuit, and a presentation annotation circuit.

The plot presentation circuit can generate one or more presentations corresponding to plots of one or more visual elements arranged according to a coordinate space. For example, the plot presentation circuit can generate one or more charts, graphs, distributions, or any combination thereof. Thus, the plot presentation circuit can provide a technical improvement to generate a plot presentation that can be selectively integrated into a user interface at a particular portion of the user interface. The plot presentation circuit can provide a technical solution to identify, from a response corresponding to a plurality of presentations, at least a portion of the response corresponding to a plot presentation, and to generate the plot presentation based on the portion of the response corresponding to one or more plot presentations. For example, a response corresponding to a plurality of presentations is a generated PIB book or PIB book data including multiple charts, multiple passages of text, and multiple links. The plurality of presentations in this example are the multiple charts, multiple passages of text, and multiple links.

The visualization presentation circuit can generate one or more presentations corresponding to one or more visual elements arranged according to a document structure. For example, the visualization presentation circuit can generate one or more tables, outlines, paragraphs, or any combination thereof, according to data of one or more sources external to content of a query. For example, the visualization presentation circuit can obtain one or more regulatory forms (including but not limited to 10K forms), real-time states (including but not limited to live stock values or orders, or live news or social media information), or any combination thereof. Thus, the visualization presentation circuit can provide a technical improvement to generate a visualization presentation that can be selectively integrated into a user interface at a particular portion of the user interface. The visualization presentation circuit can provide a technical solution to identify, from a response corresponding to a plurality of presentations, at least a portion of the response corresponding to a visualization presentation, and to generate the visualization presentation based on the portion of the response corresponding to one or more visualization presentations.

The comparative presentation circuit (comparative block from figs) can generate one or more presentations corresponding to one or more presentations. For example, the visualization presentation circuit can integrate one or more plot presentations into a comparative plot presentation, or can integrate one or more visualization presentations into a comparative plot presentation. Thus, the visualization presentation circuit can provide a technical improvement to generate a comparative presentation that can be selectively integrated into a user interface at a particular portion of the user interface. The comparative presentation circuit can provide a technical solution to identify, from a response corresponding to a plurality of presentations, at least a portion of the response corresponding to a plurality of presentations linked according to a query, and to generate the comparative presentation based on at least a portion of data corresponding to the plurality of presentations linked according to the query.

The presentation placement circuit can selectively present one or more presentations in one or more user interfaces. For example, the presentation placement circuit can determine a position or region in a presentation area of a user interface, according to one or more parameters corresponding to the user interface, a query, an entity corresponding to the query, a policy corresponding to the query, or any combination thereof. For example, the presentation placement circuit can identify one or more modular portions of the user interface corresponding to a response to a query, based on the available pixels in one or more dimensions, and one or more expected dimensions of one or more presentations according to one or more of the presentation placement circuit, the visualization presentation circuit, the comparative presentation circuit, or any combination thereof. For example, a modular portion of the user interface can be a top half of a window of the user interface that can display either text or a chart, and that displays a chart in the example of an 8K data set including chart data that is designated by a template for display in the top half of the window. For example, the presentation placement circuit can determine that a particular query includes a request for responses to be generated by the plot presentation circuit and the visualization presentation circuit. For example, the presentation placement circuit can determine that a first response to be generated by the plot presentation circuit has a first height and width in the user interface, and the visualization presentation circuit has a second height and width in the user interface. Here, the presentation placement circuit can select corresponding portions of the user interface based on the respective heights and widths of the first and second responses. Thus, the presentation placement circuit can provide at least a technical improvement of providing a user interface having one or more presentations that are customized to one or more responses to a particular query, beyond the capability of a manual process to achieve in a useful period.

The presentation annotation circuit is configured to selectively modify one or more presentations in one or more user interfaces. For example, the presentation annotation circuit can determine an object in a presentation area of a user interface, according to one or more parameters corresponding to the user interface, a query, an entity corresponding to the query, a policy corresponding to the query, or any combination thereof. An objects refers to text, paragraphs, sentences, semantic fragments, or any combination thereof, but is not limited thereto. For example, the presentation annotation circuit can identify one or more objects including but not limited to text, paragraphs, sentences, semantic fragments, or any combination thereof. For example, the presentation annotation circuit can identify one or more objects including but not limited to bitmaps, histograms, vectors, points, pixels, voxels, or any combination thereof. For example, the presentation annotation circuit can determine that a particular query includes a request for responses to be generated by the plot presentation circuit and the visualization presentation circuit. In turn, the presentation annotation circuit can determine that a first response includes an object corresponding to or semantically related to text of a query corresponding to the response. Here, the presentation annotation circuit can select corresponding portions of the response based on the correspondence of those objects to the query. For example, the presentation annotation circuit can identify a target stock mentioned in a query, and highlight a row of a stock chart generated by the visualization presentation circuit. The presentation annotation circuit can dynamically modify an annotation based on time, including, for example, to indicate whether particular information has expired. For example, information of a 10K that has been superseded by a subsequent 10K can be visualized with a particular color or visual indication corresponding to the expiration. Thus, the presentation annotation circuit can provide at least a technical improvement of providing a user interface having one or more presentations that are customized to one or more sematic or correspondence relationships to a particular query, beyond the capability of a manual process to achieve in a useful period.

Referring generally to FIG. 1, the computing system 102 may be configured to receive various queries and generate corresponding responses. The examples provided below are intended to be illustrative in nature, and are not intended to be limiting.

As one example, the computing system 102 may be configured to receive a query requesting predictive financial outcomes for a particular entity or target (or set of targets, for example as part of a merger). The computing system 102 may be configured to ingest (e.g., as an input) current financials information/data of the entities or targets (such as balance sheet, income statement, cash flows, 10k filings, board presentations, public and private regulatory filings), press or news articles from various third-party data sources, trends, and the like. In various embodiments, the computing system 102 may be configured to ingest a subset of data of interest (e.g., rather than ingesting the entirety of the data). For example, the computing system 102 may be configured to apply various filters to the data types/queries, to limit an amount of ingested data (e.g., which may in turn improve processing speeds by reducing memory occupancy). The computing system 102 may be configured to compare the ingested data (e.g., using the AI circuit 302) to similar transactions which was used as training data for generating or forecasting scenarios on the potential performance of the entities (e.g., in the case of a merger, forecast the financial outcome for instances where the merger is completed or does not move forward). The computing system 102 may generate a report which includes or outlines the forecasted scenarios, such as a probabilistic range or outcomes on revenue growth, expense controls, overall strategic value and short term and long term profitability, and the like.

In various embodiments, the computing system 102 may be configured to incorporate one or more of various constraint(s) to one or more of the query(ies). For example, the computing system 102 may be configured to ingest or leverage (e.g., as part of training and correspondingly response generation) potential regulatory constraints specific to the industry and legal framework of the different countries, to lay out potential risks to having a deal consummate. In various embodiments, depending on a particular risk, the computing system 102 may generate various actions and recommendations for risk mitigation (e.g., how to ensure regulatory compliance leading up to the approval of the merger by the corresponding regulatory or government authorities).

As an example, the computing system 102 may receive a query for candidate mergers and acquisition or activism targets. The computing system 102 may use the output generation circuit 132 (e.g., the AI circuit 302) to apply as an input, for example, fundamental data, market data, ratings, and/or other metrics. The AI circuit 302 may be trained on, for example, fundamental data (e.g., 20 year history), security prices (daily), ownership fragmentation, shareholder voting pattern, analyst recommendations, management turnover, government ratings, ESG scores, journey and targets of previous acquisitions, etc. The AI circuit 302 may also use random forest, gradient boosting machine, or other supervised methods trained on, for example, any number of campaigns or M&A deals, to generate a prediction of whether a target is likely or not to have an activism or M&A event. The output generation circuit 132 may be configured to generate a ranked ordered list of M&A targets and/or activism targets.

Referring now to FIG. 4, depicted is a staged processing flow for generating a report, according to an exemplary embodiment. The processing flow may be performed by the computing device 102 of FIG. 1. At the outset (e.g., first stage), the computing system 102 may receive a query. Following determining the context of the query (e.g., as described herein), the computing system 102 may apply the query to a first model 402, to determine an entity list 404. For example, the query may be a request for M&A prospects. The entity list 404 may be a list of entities (e.g., top 100 entities, such as privately held or public companies) which are M&A prospects. Following the first stage, the computing system 102 may use the entity list 404 to perform a query of one or more external sources 106, 108, for information relating to each of the entities of the entity list. For example, the computing system 102 may perform a query of the external databases 108 for information relating to the entities. The computing system 102 may apply the responses (e.g., information) from the external databases 108 to a second model 406, to generate a first output 408. The second model 406 may be or include an M&A signals model which is trained to generate an output indicating a likelihood of M&A activity for a particular entity given the information relating to that entity. The second model 406 may generate the first output 408 to include a sub-list of entities which have a likelihood that exceeds a threshold.

Following the second stage and determining the sub-list of entities, the computing system 102 may query internal data sources 112 (such as a document management system 112, or other database) along with various external data sources 106, 108 (such as industry databases) for information relating to the sub-list of entities. The computing system 102 may apply the information relating to the sub-list of entities as well as the output of the second model (e.g., at the second stage) to a third model 410. The third model 410 may be configured or trained to combine internal and industry data to augment the output of the sub-list of entities. As such, the third model 410 may be configured to generate a second output 412 which is a sub-list of entities which is augmented by internal and/or industry data. Once the first and second outputs 408, 412 are generated, the computing system 102 may be configured to apply the first and second outputs 408, 412 to a large language model 414 to generate a report 416, as described herein.

Referring generally to FIG. 1 together with FIG. 5A-FIG. 6F, the computing device 104 may render a user interface for facilitating interaction between a user of the computing device 104 and the computing system 102. The user interface may be or include, for example, an artificial intelligence (AI) interface which receives queries from the user, and renders responses to the queries generated by the computing system 102. In operation, the computing device 104 may establish a connection or link between the computing device 104 and computing system 102 (e.g., over a network) by providing log-in credentials or other unique identifier associated with the user to the computing system 102. Responsive to authentication/verification, the computing device 104 and computing system 102 may establish a session. As part of establishing the session, the computing device 104 may render a user interface (e.g., based on or according to data received from the computing system 102) including a text field for providing queries. Once the user submits a query, the computing device 104 may communicate the query (or data corresponding to the query) to the computing system 102 over the connection or link of the session. The computing system 102 may process the query as described above, to generate a response. The computing system 102 may transmit the response to the query over the connection or link of the session to the computing device 104, for rendering in the user interface.

Referring now to FIG. 5A and FIG. 5B, depicted are example user interfaces 500, 510 showing a query to and response from the computing system of FIG. 1, according to an exemplary embodiment. As shown in FIG. 5A, a user of the computing device 104 may enter a prompt or query regarding a target associated with a customer (e.g., a customer interested in acquiring the target). In the example of FIG. 5A, the target may be Acme Co. The query may be, for instance, “Please provide me information regarding Acme Co.” The query processing circuit(s) 130 may tokenize the query and encode the tokens for applying to a neural network of the AI circuit 302. The AI circuit 302 may generate a response which includes, for example, a summary of various information regarding the target. The information may include business strategy, products, quarterly earnings, competition, competition prices, potential M&A activity, and potential targets. The AI circuit 302 may generate the response based on the training data and inputs described above with reference to FIG. 1. The output generation circuit 132 may generate the response (e.g., using a natural language decoding of the output from the AI circuit 302) for populating or otherwise including in the user interface 510 as shown in FIG. 5B.

Referring now to FIG. 6A-6F , depicted are example user interfaces 600-650 showing a dialogue with the computing system of FIG. 1, according to an exemplary embodiment. As shown in FIG. 6A-6F , the computing system 102 may use context from previous queries and responses to generate responses. For example, while the initial query (What are some of the top M&A prospects across industries) is fairly general as shown in FIG. 6A, the second query (e.g., to share more insights of the top three companies) builds off the response to the initial query, and the computing system 102 may use the context of the initial query and response to formulate the response to the second query. A user of the computing device 104 may scroll up to view previous responses. In this regard, the queries and responses between the computing device 104 and computing system 102 may be maintained in a thread, and thus may be used as context for subsequent response generation (e.g., by the computing system 102).

In some embodiments, the report generation circuit 308 may be configured to generate a report based on the responses to the series of queries. For example, the user interfaces 600-650 may include a user interface element for generating a report (e.g., “Generate Report” button, as one example). Upon receiving the selection, the report generation circuit 308 may be configured to generate a report which includes, incorporates information from, summarizes, or otherwise relates to the responses to each query within the thread. For example, the report may include each of the graphics/tables/etc. generated in response to respective queries, a summary of each of the queries, and a summary (e.g., as a title or subject matter summary) of the thread. The computing system 102 may communicate, transmit, or otherwise provide the report to the computing device 104. The user of the computing device 104 may provide the report as a deliverable to a customer or enterprise, use the report for generating a corresponding deliverable (such as a slide deck or some other deliverable), and so forth.

In various embodiments, the computing system 102 may scrub various internal data from the responses according to the audience (e.g., as indicated by a unique identifier or token associated with the computing device 104) (e.g., to remove internal insights, internal data from the summaries, etc.).

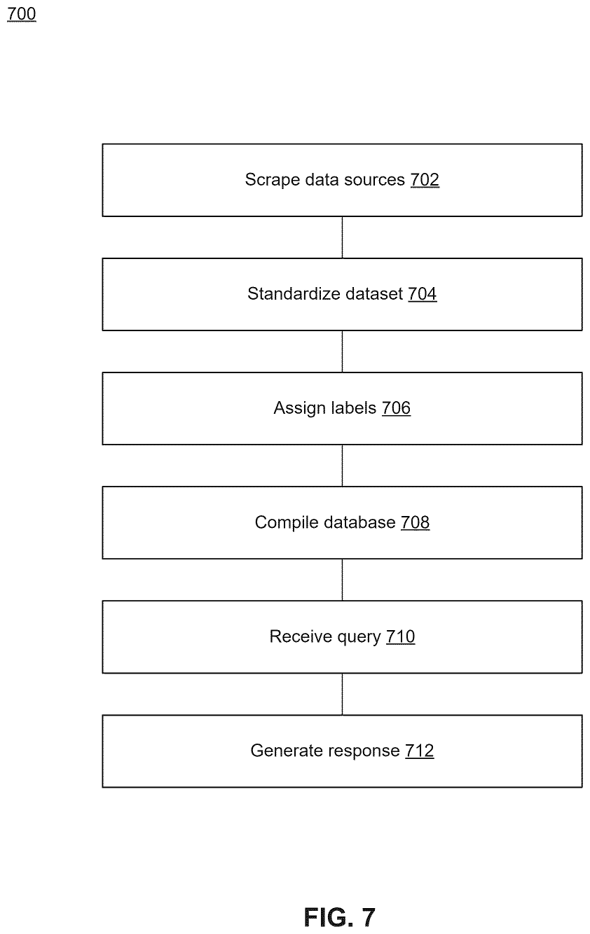

Referring now to FIG. 7, depicted is a flowchart showing an example method 700 of providing an intelligent banking service, according to an exemplary embodiment. The method 700 may be performed by the devices/components/elements described above with reference to FIG. 1-FIG. 6F. As a brief overview, at step 702, a computing system scrapes data sources. At step 704, the computing system generates a standardized dataset. At step 706, the computing system assigns labels. At step 708, the computing system compiles a database. At step 710, the computing system receives a query. At step 712, the computing system generates a response.

At step 702, a computing system scrapes one or more data sources. In some embodiments, the computing system may scrape one or more data sources of the computing system (e.g., internal data sources) and scrape one or more external data sources (e.g., data sources of one or more external computing systems). For example, the computing system may be associated with an institution or enterprise (such as a bank or financial institution). The computing system may scrape data sources of the financial institution, as well as third-party data sources. Such internal data sources may include, for example, customer relationship management (CRM) data sources, document management systems (DMS), deal books, bookbuild platform, past agreements, etc. The external data sources may include, for example, various financial reporting and news sources/databases, such as Factset, Refinitiv, CapIQ, S&P, Moody's, Bloomberg, Markit, Syndtrack, D&B, Edgar, etc. The computing system may scrape the internal and external data sources to compile or collect a first dataset. In some embodiments, the computing system may scrape the data sources at various intervals (e.g., daily for certain information, quarterly for other information, yearly for other information, etc.). For example, the computing system may scrape the data sources daily for security prices, news articles, etc., quarterly for earnings reporting, yearly for fundamental data, etc. The computing system may scrape the data sources by performing periodic API calls, by executing data request queries at various intervals, etc.

At step 704, the computing system generates a standardized dataset. In some embodiments, the computing system may standardize the first dataset (e.g., scraped at step 702) to generate a standardized dataset. The standardized dataset may be or include a dataset which has a common format, structure, or schema across data entries. In some embodiments, the computing system may generate the standardized dataset by performing data mapping and transformations for each data entry of the dataset. At step 706, the computing system assigns labels. In some embodiments, the computing system may assign labels to the data entries of the standardized dataset generated at step 704. The computing system may assign labels to the data entries by applying an artificial intelligence (AI) algorithm to the data entries, to assign labels to the data entries. The AI algorithm may be or include, for example, Snorkel AI, or some other labeling algorithm for data labeling.

At step 708, the computing system compiles a database. In some embodiments, the computing system may compile a database with the standardized dataset having labels assigned thereto. In this regard, the computing system may compile a database with the standardized and labeled data entries (e.g., responsive to performing steps 704 and 706). The computing system may compile the database with data entries which are to be used for AI training (e.g., at the training phase) and for adding context/insights as an input to a trained AI model (or models) at the deployment phase.

At step 710, the computing system receives a query. In some embodiments, the computing system may receive (e.g., via an AI interface) a query from a computing device. The query may be received responsive to the computing device establishing a session with the computing system. In some embodiments, the query may include an inquiry for information relating to an enterprise (e.g., financial information, prospective information, predictions, M&A targets, etc.). At step 712, the computing system generates a response. In some embodiments, the computing system may generate a response to the query for delivering via the AI interface to the computing device.

In some embodiments, the computing system may generate the response by first processing the query. The computing system may process the query by tokenizing the prompt corresponding to the query (e.g., breaking up or dividing the query into words or sub-words), and encoding the tokens of the prompt to have a format which is compatible with an AI model of the computing system (e.g., a vector or numerical representation of the tokens corresponding to the prompt). The computing system may apply the encoded tokens to an AI model trained to determine (at least) a context of the query. Responsive to determining the context, the computing system may generate a query or request to, for example, the database/data sources (e.g., scraped data sources), for contextual information (e.g., one or more data entries) relating to the query. For example, where the context of the query is requesting information relating to a particular company or entity, the computing system may generate a query for the database/data sources for contextual information relating to the particular company or entity. The computing system may receive a response including the contextual information. The computing system may apply the contextual information as an input to the AI model (e.g., as well as the encoded tokens) to generate the response. The response may include information relating to the company (e.g., based on the contextual information) as well as predictions made based on the contextual information (such as predicted financial outlook, likelihood of M&A activity with respect to the company, etc.).

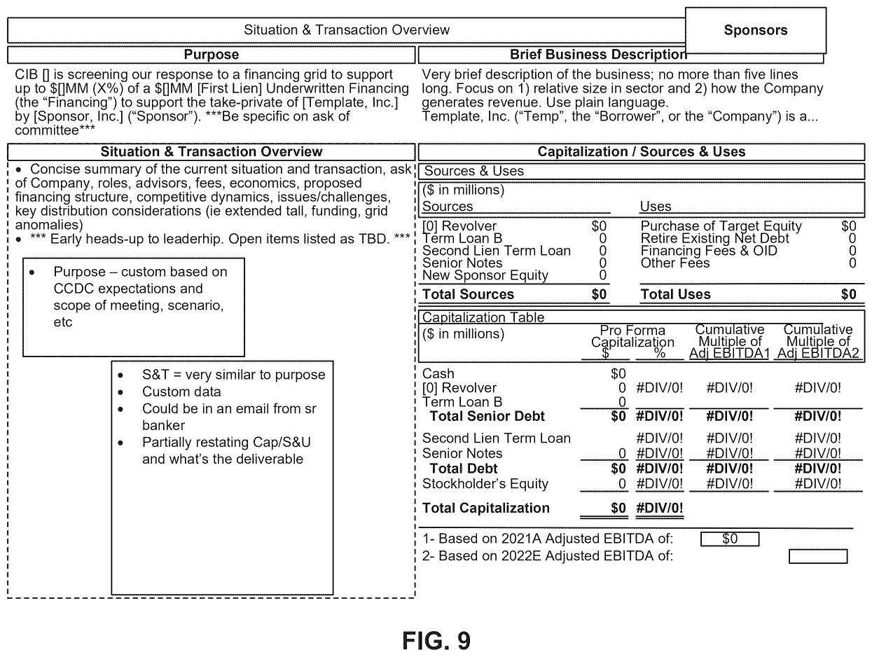

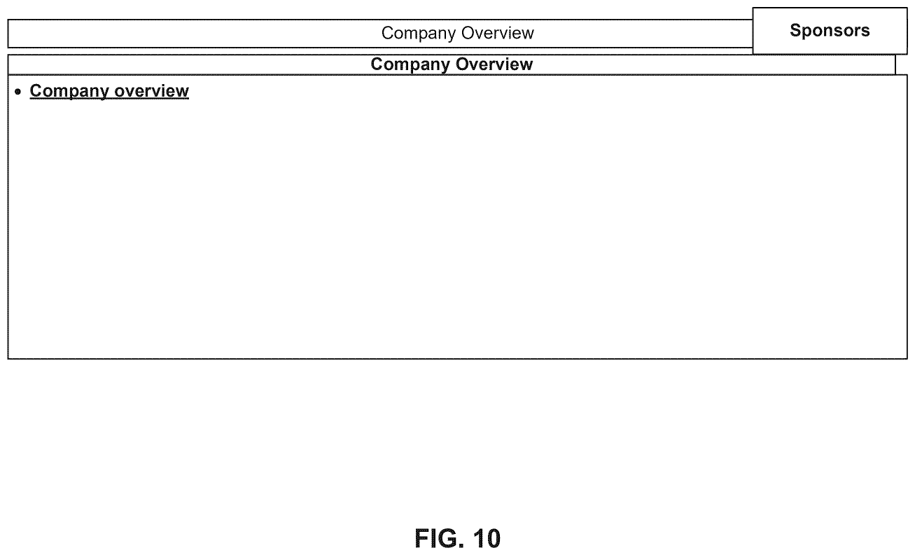

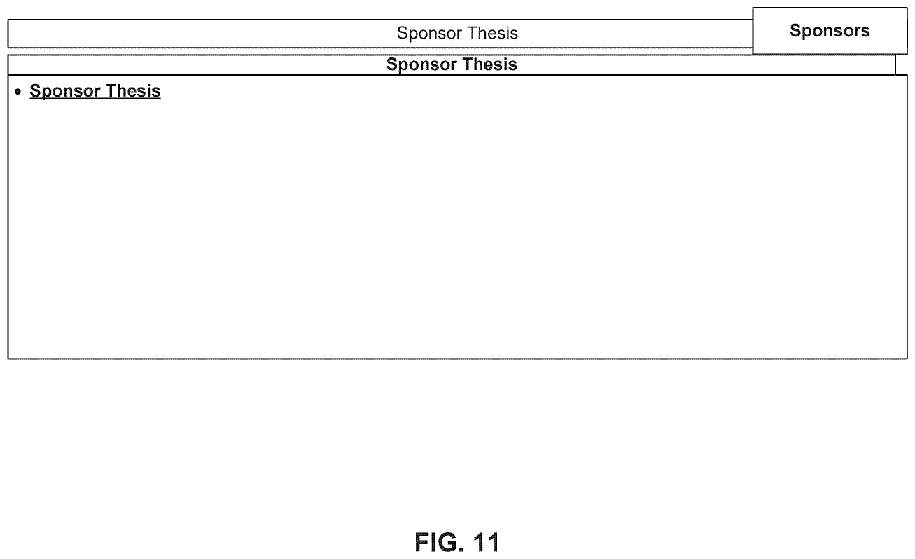

FIG. 8-FIG. 14 are example user interfaces showing a presentation of PIB book data and presentations with the computing system of FIG. 1, according to an exemplary embodiment. For example, FIG. 8-FIG. 12 illustrate various sponsor screen presentations. The sponsor screen presentation of FIG. 8 is a user interface that includes modular portions. The modular portions are, in this example, Deal Team, Dashboard, and Exposure & Fee Summary sections. The individual listings in these sections are also nested modular portions. For example, FIG. 9 illustrates a sponsor screen presentation. The sponsor screen presentation of FIG. 9 is a user interface that includes modular portions. The modular portions are, in this example, Purpose, Situation & Transaction Overview, Brief Business Description, and Capitalization/Sources & Uses sections. The individual listings in these sections are also nested modular portions. For example, FIG. 10 illustrates a sponsor screen presentation. The sponsor screen presentation of FIG. 10 is a user interface that includes a modular portion. The modular portion is, in this example, a Company Overview section. For example, FIG. 11 illustrates a sponsor screen presentation. The sponsor screen presentation of FIG. 11 is a user interface that includes a modular portion. The modular portion is, in this example, a Sponsor Thesis section.

For example, the computing system can provide at least two options for how peer data or competitor data gets displayed in comparison to the subject company in the chart. For example, these options include 1) entry of a list of individual company names, or 2) creating one or many constituency groups. For example, a constituency group can correspond to a set of one or more companies having a common property (e.g., same sector, same board member, same tier of market capitalization), or any combination of properties. For example, the computing device can, based optionally on one or more instructions or data from the computing system, receive input from a user to name or delete a constituency group. For example, the computing device can, based optionally on one or more instructions or data from the computing system, receive input from a user to enter one or many company names or ticker symbols within a constituency group. For example, the computing system or the computing device can auto-suggest one or more names based on a database of available names. For example, the computing device can, based optionally on one or more instructions or data from the computing system, receive input in a list view from a user to save and recall a chart created by a given user. For example, the computing system can summarize the annotations that were created.

For example, the computing device can, based optionally on one or more instructions or data from the computing system, receive input to Q&A the annotation summary for a given chart or company. For example, the computing device can, based optionally on one or more instructions or data from the computing system, receive input to select the word count length of the annotation summary. For example, the computing device can, based optionally on one or more instructions or data from the computing system, provide output on a home screen of the computing device, to see a previously created “document-list-view” list view of all the PIBs that were previously created by a given user or by others. For example, the computing device can, based optionally on one or more instructions or data from the computing system, receive input on a home screen of the computing device, to search for a previously created PIB by company name, ticker symbol, Managing Director name, file name, or username that created the PIB (for a given user or other users). For example, the computing device can, based optionally on one or more instructions or data from the computing system, provide output on a home screen of the computing device including a table to provide the user with useful column data including at least one of whether a company is public or private, file name, ticker symbol, managing director name, file creator, or creation date.

For example, the computing device can, based optionally on one or more instructions or data from the computing system, receive input on a home screen of the computing device, to refresh any PIB created in the past so that it has the newest content (e.g., current or breaking news content received with a real-time interface with an external system). For example, the computing device can, based optionally on one or more instructions or data from the computing system, receive input on a home screen of the computing device, to save the newly refreshed document under a new file name, to replace the old file, and to change the managing director name. For example, the computing device can, based optionally on one or more instructions or data from the computing system, provide output on a home screen of the computing device including a table to provide the user with a notification column that indicates if the company has published newer earnings or whether a newer news article relevant to the timestamp and the company associated with an annotation is available. For example, a newer article can correspond to a new article published at a time that is later than another article. For example, the computing device can, based optionally on one or more instructions or data from the computing system, provide output to either rename the new version (e.g., copy) or replace the old (e.g., refresh).

For example, FIG. 13 illustrates a summary screen presentation. The summary screen presentation of FIG. 13 is a user interface that includes modular portions. The modular portions are, in this example, Trading Summary and Trading History sections. The individual listings and tables in these sections are also nested modular portions. For example, FIG. 14 illustrates a credit overview screen presentation. The credit overview screen presentation of FIG. 14 is a user interface that includes modular portions. The modular portions are, in this example, Key Credit Metrics, and Key Credit Considerations sections. The individual listings and text passages in these sections are also nested modular portions.

FIG. 15-FIG. 17 are associated with user stories for the respective buckets of document creation automation, document summarization, document Q&A interactions, and data visualizations as described herein above. The user stories are presented by way of example in a sequence of how users may navigate the experience from start to finish. For example, each user interface includes a side menu where various variables can be selected before generating the research materials, shown as a PIB herein. The user interfaces of FIG. 15-FIG. 17 may be presented by the user device and/or other system device described above with reference to FIG. 1 FIG. 6F.

FIG. 15 is a user interface showing a presentation of PIB book data and presentations with the computing system of FIG. 1 (e.g., via a display device of the computing device 104), according to an exemplary embodiment. Initially, a user may be searching for a company with the provided field, and may desire the ability to enter a company name or ticker symbol while typing. The system 102 or computing device 104 can begin to auto-populate the content so that the user can select the content. The user may select from a set of main categories for a PIB via the computing device 104. These categories are, but are not limited to, company information/earnings transcripts, data sources (e.g., internal or external to a provider computing system), equity research reports, company filings & presentations, recent news, and industry reports. Then, the provider computing system 102 may use one or more application program interfaces (APIs) so that PIB content, or certain PIB content, can be collated automatically. For example, the user interface 1500 includes a side pane 1510 and a preview region 1520. The preview regions 1520 can include a time notification (e.g., a popup at center).

The user, via the computing device 104, may specify a handful of variables for each of section of the PIB, according to Company Information, Equity Research Reports, or a time period (e.g., 1 yr, 90 days, 6 months, 30 days, 7 days or less). The user has the ability to select one or many companies from, for example, a list including various banks and investment banks. The computing device 104 provides the user with the ability to enter other company names that are not readily available from the options presented to the user. The computing device 104 provides the user with the ability to deselect one or more companies from this group. For company filings & presentations, the user may select the number of quarters desired for recent quarters of company filings (e.g. financials), the amount of quarters for earnings transcripts (most recent plus how many more), recent news, the ability to select a data source. For Industry Reports, if available, the user may specify industry/sector and timeframe (e.g., within the last 12 months).

The user, via the computing device 104, can specify the company information section to have a company overview page if available (e.g., populated from an external database from the provider computing system) and can specify Company Information to include a tear sheet that contains the below information, accessible by various user interface menus. The user interface menus can be presented in the sidebar 1510 of FIG. 15, or the like. A “Snapshot” is obtained by a nested menu having a path from “FactSet” to “Overviews” to “Snapshot.” A “Board & Management” page is obtained by a nested menu having a path from “FactSet” to “Activism, Management, and . . . ” to “Management & Board.” A “Shareholder Overview” is obtained by a nested menu having a path from “FactSet” to “Ownership” to “Ownership Summary.” An M&A Overview is obtained by a nested menu having a path from “FactSet” to “News, Research, and Filings” to “M&A Deals.” A Shark Repellent Summary is obtained by a nested menu having a path from “FactSet” to “Activism, Management, and . . . ” to “Corporate Governance” to “Down.” The menu structures and menu nesting of this disclosure are not limited to the menus or nesting described herein by way of example. The tear sheet may be a high-level overview of a given company pulled from FactSet. For example, the tear sheet may be a 10-12-page PDF containing information on the company's financials, governance, management, ownership, M&A history, and many more figures).

The user, via the computing device 104 and for the document section Company Information has Earnings Transcripts pulled for the past three quarters (Earnings Transcripts can be extracted from either Bamsec or Factset API). The user, via the computing device 104 and for the section “Equity Research” (ER) may select this feature and the computing device 104 displays at least two ER reports for each earnings transcript that the user has specified within the Company Information/Earnings Transcript section. Via the computing device 104, the user may request data in the section “Company Filings/Investor Presentations,” including most recent 10K filings, most recent 10Q filings, most recent earnings release, most recent earnings call transcripts, most recent proxy statements, or most recent earnings presentation. As discussed herein, “most recent” can be after a predetermined date or one or more items created or modified at a latest date.

Regarding the “recent news” section, the system 102 may compile various articles from reputable sources within a past predefined time period (e.g., within the last year). For example, “general news,” “top news,” etcetera in the headings being examined by the system 102 to identify strategic news, such as senior management shakeups (e.g. John Doe named new CFO), any divesting, acquisition, and so on. Via the computing device 104 and regarding the industry reports section, the user may obtain reports within a specific industry/sector and timeframe (e.g., within the last 12 months). Once a PIB is generated by the computing system 102, the user is presented a summary via the computing device 104 that tells the user what was not able to be pulled as a notification in the user interface (in other words, the user has a glance view of what was not included so that the user does not have to manually review the large document). The computing device 104 may provide the first page of the PIB as a cover-page that contains the titles to each section and sub-section within the graphical user interface. Via the computing device 104, the user is provided with the ability to export the PIB directly to various document formats (e.g., as Word document, as a PDF, etc.). While the PIB is being generated, the user via the computing device 104 may receive a notification that indicates how long an estimate to generate the PIB may be. In one embodiment, if the user exits the application on the client device 104, generation of the PIB may cease. In another embodiment, generation of the PIB may continue but the user is required to provide the appropriate authentication information to access the information at a later date.

One example iteration relates to document creation of private documents. This represents a different feature provided by the system 102 and computing device 104. Similar processes are described as above in certain instances. A user, upon selecting the radio button for “private company” in the main menu graphical user interface of the computing device 104 can cause the main categories to read/be displayed differently than the ones presented for public companies. For example, these categories may include: company information, recent news, equity research for public peers, industry reports. For the user that is getting ready to create a PIB, the user may specify via the computing device 104 one or more variables for each of the respective sections of the PIB. These variables may include, but are not limited to, Company Information, Recent News, Equity Research for Public Peers, an ability to add peers through a field that auto-populates by ticker or company name, an ability to deselect one or many public peers, Industry Reports (if available), and/or an ability to select the industry/sectors of interest and timeframe (within the last 12 months or less).

For the Company Information section and via the computing device 104, the user may request a tear sheet which contains at least a portion of the below information, accessible by various user interface menus. The user interface menus can be presented in the sidebar 1510 of FIG. 15, or the like. A “Snapshot” is obtained by a nested menu having a path from “FactSet” to “Overviews” to “Snapshot.” A “Board & Management” page is obtained by a nested menu having a path from “FactSet” to “Activism, Management, and . . . ” to “Management & Board.” A “Shareholder Overview” is obtained by a nested menu having a path from “FactSet” to “Ownership” to “Ownership Summary.” An M&A Overview is obtained by a nested menu having a path from “FactSet” to “News, Research, and Filings” to “M&A Deals.” A Shark Repellent Summary is obtained by a nested menu having a path from “FactSet” to “Activism, Management, and . . . ” to “Corporate Governance” to “Down.” The menu structures and menu nesting of this disclosure are not limited to the menus or nesting described herein by way of example. The tear sheet may be a high-level overview of a given company pulled from a resource, such as FactSet. The tear sheet may be a ten-twelve (sometimes longer, sometimes shorter) document containing information on a target company's financials, governance, management, ownership, M&A history, and many more figures.

Via the computing device 104 and in the “recent news” section, the user may request various articles from sources compiled within the past predefined time period (e.g., over the last year). For example, “general news,” “top news,” etcetera in the headings being examined by the system 102 to identify strategic news, such as senior management shakeups (e.g. John Doe named new CFO), any divesting, acquisition, and so on. The computing device 104 may provide the first page of the PIB as a cover-page that contains the titles to each section and sub-section within the graphical user interface. Via the computing device 104, the user is provided with the ability to export the PIB directly to various document formats. While the PIB is being generated, the user via the computing device 104 may receive a notification that indicates how long an estimate to generate the PIB may be. In one embodiment, if the user exits the application on the client device 104, generation of the PIB may cease. In another embodiment, generation of the PIB may continue but the user is required to provide the appropriate authentication information to access the information at a later date.

Another example operation implementation relates to document summarization. here, the computing system 102 can provide a document summarization process that may include similar processes as described above with, for example, the private document creation process. For example, the computing system 102 generates summarizations that are responsive to a given query and lack a specific framework for a structure of a response to the given query. Sometimes, users may need to summarize documents related to legislation or a PIB. Sometimes, users may need to create a summary from a 10K. The computing system 104 can obtain a given query that can vary based on the intended audience. Examples of queries are discussed below.

For example, the computing system 104 can receive input directed to request one or more queries in one or more inputs. For example, a query can include text to request “a brief company overview to include HQ location, founding year, and industry that they operate in.” For example, a query can include text to request “two equity research reports for each quarter.” For example, a query can include text to request to “call out any M&A transactions that occurred in 1990.” For example, a query can include text to request for “what the analyst from Investment Bank A had to say as a result of the 2022 M&A deal that transpired in 1990.” For example, a query can include text to ask “Is Company A using Price to book valuation? If not, what is the valuation method being used?” For example, a query can include text to request “the main consumer impacts for this legislation” as listed in bullet points within the query. For example, a query can include text to identify “the main impacts to companies that operate within X industry.” For example, a query can include text to ask “Has there been any mention within the document of X incident? If so, add that to the summary that was just created?” For example, a query can include text to ask “As a result of Company A's acquisition of Company X, what was the goodwill adjustment?” The computing device 104 can receive one or more queries, including one or more queries according to the ne or more queries, including queries as noted above,

Via the computing device 104 and still within this operating experience, the user is provided the ability to upload a document for summarization. Via the computing device 104, the user may be given various options associated with the summarization, such as to select a summary word count or page length. The user, via a chat box provided via the customer device 104, may query one or more questions regarding the document that the user uploaded. For example, questions can be in one or more prompt categories that may and may not be effective for users. Categories may include basic number retrieval, basic comparison, complex comparison, or other types of categorizations. For example, the user interface of the computing device 104 can include as a visual frequently asked question section with dots plotted on an axis to show prompt categories that may and may not be effective for them. Still within this user experience feature, the user is provided the ability via a graphical user interface of the computing device 104 to export the summary directly to a desired document format. In one example and via the computing device 104 graphical user interface, the user is presented a complete summarization that includes a list of citations. For example, citations are displayed by one option to indicate to the user the page and section of the document from where the information was sourced. The user may additionally activate one or more non-user features. For example, a non-user features is a backend classification of the question and prompt types being asked across all users, an average count of follow up questions that users have based on their initial query, a prompt abandonment decision or action, or other prompt-related data for creating better experiences in the future.

FIG. 16 is a user interface showing a presentation of PIB book data and presentations with the computing system of FIG. 1, according to an exemplary embodiment. The user interface 1600 includes an AI assistant pane 1610 and a results portion 1620. The AI assistant pane 1610 include a conversational AI interface arranged according to a timeline view.

FIG. 17 is a user interface showing a presentation of PIB book data and presentations with the computing system of FIG. 1, according to an exemplary embodiment.

Via the computing device 104, the user is provided the ability to enter a parent company name into a field as a source to compare others against. The field may auto-populates a list of available options the user can select. The user may then be provided with the ability to specify a date range and an interval of time for data to be displayed on the chart (e.g., 2 years with an interval of “months”). The user may also be provided with the ability to specify equities trading change percentage where auto-generated annotations will to appear (e.g., greater 5% swing up or down is equal to an auto-annotate). Via the computing device 104, the user specifies the title to a chart to be X Company has (underperformed or overperformed) the market and Peers by X % since (date range specified). Via the computing device 104, the user is provided the option to export a data visualization into a desired format (e.g., as a spreadsheet, as a PowerPoint presentation, etc.). Via the computing device 104, the user has the option to view the source of any auto-generated annotation by a click of the annotation on the graphical user interface of the computing device 104. On click or selection of the annotation, a new tab will open in the browser that directs the user to the external source from where the information was obtained. The user may edit the text for any auto-generated annotation on the generated chart. The user may also delete any auto-generated annotation on the generated chart. Additionally, the user may selects all of the auto-generated annotations to be summarized (e.g., into a predefined length, such as one-two paragraphs).

Via the computing device 104, the user is presented with and can select various options for how peer data or competitor data is displayed in comparison to the subject company in the chart. For example, these options include 1) the user providing a list of individual company names, or 2) the user creating one or many constituency groups. The user may name or delete a constituency group that the user creates. Further and via the computing device 104, the user may enter one or many company names or ticker symbols within a constituency group. For example, these names are auto-suggested based on a database of available names. The user, via the computing device 104, may save and recall the chart in a list view. The system 102 or computing device 104, or a combination thereof, may summarize the annotations that were created (this could be a combination of automatic annotations or manually entered annotations) upon a request by the user. The user has the ability to provide queries and receive replies regarding the annotation summary. The user, via the computing device 104, may select various features of the document, such as the ability to select the word count length of the annotation summary.

For example, the computing system can receive input from the computing device to specify a date range and interval of time for data to be displayed on the chart (e.g. 2 years with an interval of “months”). For example, the computing system can receive input from the computing device to specify a threshold, corresponding to an equities trading change percentage, for which the computing system generates auto-generated annotations (e.g. auto-annotate any swing up or down that is greater than or equal to 5%). The computing system can set a title of a given chart based on received data according to a news article. For example, the computing system can set a title of a given chart to “X Company has Underperformed (or Overperformed) the Market and Peers by X % since Q1 (or any date range specified).

For example, given any source of publicly available data, a system according to this disclosure can generate content (e.g., charts, documents) that compare their clients against peer groups. The system can incorporate into the content various annotations to highlight relevant news stories. The system can link given news content to a portion of chart data having values corresponding the news event. For example, the system can identify a date associated with a news article, and can identify text in the news article that at least partially matches a company name. The system can identify a stock value chart matching the company name, and an modify the chart or add an element to the chart as an annotation that describes content of the news article. The system can place the annotation at a position on the chart that corresponds to a date in the chart matching a date of the news article. Thus, the system can present one or more annotations to explain various peaks and valleys in the data with respect to extrinsic data corresponding to one or more news events relevant to one or more companies.

For example, the computing system can export a data visualization or chart as discussed herein, or any text content based thereon, into local documents at the computing device (e.g., Excel and PowerPoint). For example, the computing device can, based optionally on one or more instructions or data from the computing system, present a link to a source of any auto-generated annotation. For example, the computing device can present source of the annotation in response to a user input corresponding to a click action of the annotation. In response, the computing device can open a new tab in a browser (or other client application of the computing device) that directs the user to the external source (e.g., web page) from where the information was obtained. For example, the computing device can, based optionally on one or more instructions or data from the computing system, edit the text for any auto-generated annotation on a chart. For example, the computing device can, based optionally on one or more instructions or data from the computing system, delete any auto-generated annotation on my chart. For example, the computing device can summarize one or more auto-generated annotations (e.g., into 1-2 paragraphs).

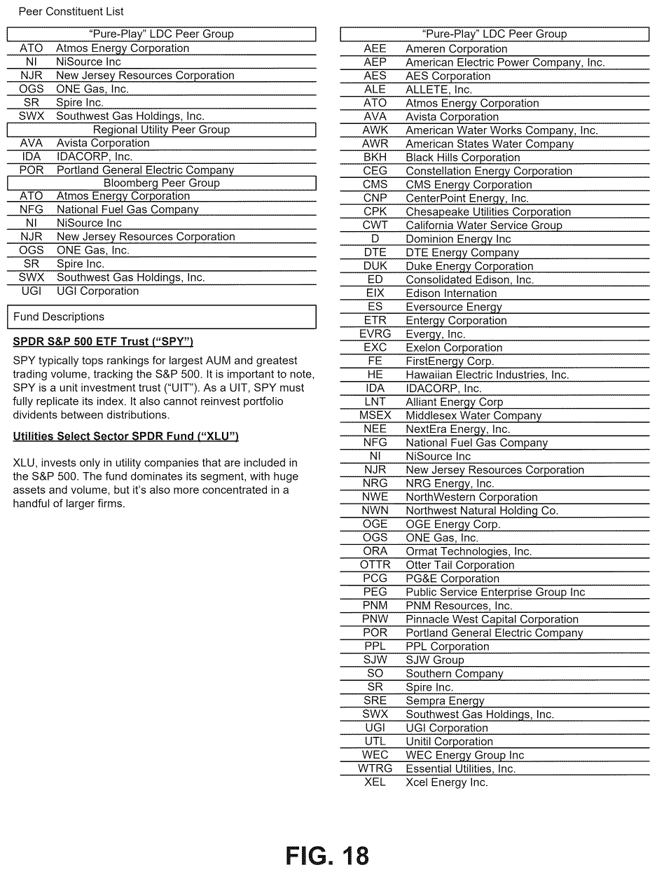

Additional user interfaces of the PIB or research generally may also be provided via the computing device 104. For example, FIG. 18 shows data that can be obtained to generate and present the PIB book data in user interfaces or presentations of any of FIG. 8-FIG. 17, according to an exemplary embodiment. For example, the data includes 8K and 10K Summaries. These 8K and 10K documents are included in the PIB and also summarized by the Investment Bankers.

Generating a PIB can require various time-consuming actions. For example, constructing a PIB can manually take 2 hours. Constructing general company information (Factset Tear Sheet or Company Website) can manually take significant time. Constructing Equity Research (in addition to pulling equity research, the user may need to scan through and use best judgement on the number of reports (and which sources) to add to PIB and filter out reports that are roughly the same. On the other hand, if something drastic happens within a specific quarter, the user may desire to show multiple reports for that same period to provide insight into the thoughts of many analysts even if the opinions are similar. This can manually take, for example, 30 minutes. Company Filings/Earnings and Associated Transcripts compilation can manually take, for example, 15 minutes. Constructing Recent News requires filtering through many (especially for a public company) news articles and press releases to determine which is relevant in the specific context of the ask. For example, a PIB for an initial client meeting could look different from a PIB that was generated as part of an ongoing strategic client relationship). This can manually take, for example, 30 minutes. Industry Reports requires a read through and judgement on relevancy. This can manually take, for example, 30 minutes. A computing system 102 as discussed herein mitigates or eliminates at least partially or completely the time required by one or more of the actions. For example, the computing system 102 can eliminate all for the time required by the above actions, to achieve a technical improvement that is beyond the capability of manual processes, due to the specificity and scale of numbers of summaries per PIB.

Generating a 6-12 page summary can require various time-consuming actions. It is uncommon for a user to prepare a 12 or 6 page summary from scratch. The user may determine that 1 or 2 pages from a filing, 1 or 2 news articles, or 1 or 2 research reports provide great information and should be highlighted when providing to the senior banker. They may even copy and paste a few lines from the document in the body of the email when sending to senior banker. Assuming that the ANL/ASO is thinking about the summary and developing in tandem with the PIB creation, this can manually take, for example, 15 minutes. These summaries are beyond the capability of manual processes, due to the specificity and scale of numbers of summaries per PIB.

Generating an equities trading chart with annotations can require various time-consuming actions. The timing here is associated with spending the time to determine the reasoning behind any significant changes in the data. One may have to review the earnings releases/transcripts, recent company news, or sometimes even recent news on the economy as a whole. This can manually take, for example, 30-45 minutes. All of these actions become cumbersome at the scale needed to react to business conditions, and these manual processes cannot be performed accurately or rapidly enough to adequately react to business conditions. Thus, this technical solution provides a technical improvement beyond mere automation, to enable a higher degree of information awareness at a lower latency than is achievable by manual processes.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include software for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

Accordingly, the “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method comprising:
scraping, by a first computing system, first data of one or more first data sources of the first computing system, and second data one or more second data sources of one or more external computing systems, wherein the one or more second data sources are scrapped according to a time period;
receiving, by an AI interface of the first computing system, a string of queries from a computing device relating to a target entity;
generating, by the first computing system, for each query of the string of queries, a respective response according to the first data and the second data, and a prior query of the string of queries, each response displayed within the AI interface; and
causing, by the first computing device, display of a plurality of tabs within the AI interface, each tab corresponding to at least a portion of information relating to the responses to the string of queries to be displayed within the AI interface.

2. The method of claim 1, wherein a tab of the plurality of tabs comprises a nested menu for displaying different views of the portion of the information.

3. The method of claim 1, wherein at least one of the one or more second data sources comprise an external news source, and wherein the first computing system scrapes the second data sources using at least one of an application program interface (API) call of the external news source, a standard query language (SQL) request, or a hyptertext transfer protocol (HTTP) GET request.

4. The method of claim 3, wherein scraping the one or more second data sources is responsive to receiving at least one query of the string of queries, and wherein the one or more second data sources are scraped according to a context of the at least one query.

5. The method of claim 1, further comprising generating, by the first computing system, a plurality of presentations responsive to a request from at least one of the string of queries.

6. The method of claim 5, wherein each tab corresponds to a respective presentation of the plurality of presentations.

7. The method of claim 1, further comprising:
receiving, by the first computing system, following selection of a first tab of the plurality of tabs to display the corresponding portion of information within the AI interface, a subsequent query via the AI interface;
generating, by the first computing system, a subsequent response according to the subsequent query and using at least some of the portion of information within the AI interface; and
displaying, by the first computing system, information relating to the response within the AI interface.

8. The method of claim 7, wherein displaying the information relating to the response comprises:
overlaying, by the first computing system, the information relating to the response, within a region of the AI interface which corresponds to the portion of information.

9. The method of claim 1, further comprising:
for each query of the string of queries,
generating, by the first computing system, a plurality of tokens representing the query;
encoding, by the first computing system, each token into a corresponding encoded token;
applying, by the first computing system, the encoded tokens to an AI model, to determine a context associated with the query;
requesting, by the first computing system, one or more data entries the one or more first data sources or the one or more second data sources, the one or more data entries requested according to the determined context;
applying, by the first computing system, data corresponding to the one or more data entries and the encoded tokens to the AI model; and
generating, by the first computing system, the response based on an output from the AI model.

10. A first computing system, comprising:
one or more processors configured to:
scrape first data of one or more first data sources of the first computing system, and second data one or more second data sources of one or more external computing systems, wherein the one or more second data sources are scrapped according to a time period;
receive, via an AI interface of the first computing system, a string of queries from a computing device relating to a target entity;
generate, for each query of the string of queries, a respective response according to the first data and the second data, and a prior query of the string of queries, each response displayed within the AI interface; and
cause display of a plurality of tabs within the AI interface, each tab corresponding to at least a portion of information relating to the responses to the string of queries to be displayed within the AI interface.

11. The first computing system of claim 10, wherein a tab of the plurality of tabs comprises a nested menu for displaying different views of the portion of the information.

12. The first computing system of claim 10, wherein at least one of the one or more second data sources comprise an external news source, and wherein the one or more processors scrape the second data sources using at least one of an application program interface (API) call of the external news source, a standard query language (SQL) request, or a hyptertext transfer protocol (HTTP) GET request.

13. The first computing system of claim 12, wherein the one or more processors scape the one or more second data sources responsive to receiving at least one query of the string of queries, and wherein the one or more second data sources are scraped according to a context of the at least one query.

14. The first computing system of claim 10, wherein the one or more processors are configured to generate a plurality of presentations responsive to a request from at least one of the string of queries.

15. The first computing system of claim 14, wherein each tab corresponds to a respective presentation of the plurality of presentations.

16. The first computing system of claim 10, wherein the one or more processors are configured to:
receive, following selection of a first tab of the plurality of tabs to display the corresponding portion of information within the AI interface, a subsequent query via the AI interface;
generate a subsequent response according to the subsequent query and using at least some of the portion of information within the AI interface; and
display information relating to the response within the AI interface.

17. The first computing system of claim 16, wherein, to display the information relating to the response, the one or more processors are configured to overlay the information relating to the response, within a region of the AI interface which corresponds to the portion of information.

18. The first computing system of claim 10, wherein the one or more processors are configured to:
for each query of the string of queries,
generate a plurality of tokens representing the query;
encode each token into a corresponding encoded token;
apply the encoded tokens to an AI model, to determine a context associated with the query;
request one or more data entries the one or more first data sources or the one or more second data sources, the one or more data entries requested according to the determined context;
apply data corresponding to the one or more data entries and the encoded tokens to the AI model; and
generate the response based on an output from the AI model.

19. A non-transitory computer readable medium storing instructions that, when executed by one or more processors of a computing system, cause the computing system to:
scrape first data of one or more first data sources of the computing system, and second data one or more second data sources of one or more external computing systems, wherein the one or more second data sources are scrapped according to a time period;
receive, via an AI interface of the computing system, a string of queries from a computing device relating to a target entity;
generate, for each query of the string of queries, a respective response according to the first data and the second data, and a prior query of the string of queries, each response displayed within the AI interface; and
cause display of a plurality of tabs within the AI interface, each tab corresponding to at least a portion of information relating to the responses to the string of queries to be displayed within the AI interface.

20. The non-transitory computer readable medium of claim 19, wherein the instructions further cause the computing system to:
for each query of the string of queries,
generate a plurality of tokens representing the query;
encode each token into a corresponding encoded token;
apply the encoded tokens to an AI model, to determine a context associated with the query;
request one or more data entries the one or more first data sources or the one or more second data sources, the one or more data entries requested according to the determined context;
apply data corresponding to the one or more data entries and the encoded tokens to the AI model; and
generate the response based on an output from the AI model.
